(19) United States
(12) Patent Application Publication
(10) Pub. No.: US 2026/0308886 A1
(43) Pub. Date: Oct. 8, 2026

(54) CONSTRUCTION MACHINE

(71) Applicant: KOBELCO CONSTRUCTION MACHINERY CO., LTD., Hiroshima-shi (JP)

(72) Inventors: Sho OKIMOTO, Hiroshima (JP); Yasuhiko SHIMAZU, Hiroshima (JP); Kazushige KOIWAI, Hiroshima (JP); Masatoshi KOZUI, Hiroshima (JP)

(73) Assignee: KOBELCO CONSTRUCTION MACHINERY CO., LTD., Hiroshima-shi (JP)

(21) Appl. No.: 19/482,108

(22) PCT Filed: Jun. 24, 2024
(86) PCT No.: PCT/JP2024/022764

§ 371 Date: Nov. 6, 2025

(30) Foreign Application Priority Data
Jul. 7, 2023 (JP) 2023-112400
May 30, 2024 (JP) 2024-087998

(51) Int. Cl. E02F 9/26; E02F 3/43; E02F 9/22; G01G 19/08

(52) U.S. Cl. CPC E02F 9/26; E02F 3/435; G01G 19/08; E02F 9/2203; E02F 9/2285; E02F 9/2292

(57) ABSTRACT

A construction machine includes a machine body, a work attachment that includes a bucket, a weight detection unit capable of detecting a weight of the earth held by the bucket and a hardness estimation unit for estimating hardness of the ground. When estimating the hardness of the ground, the hardness estimation unit executes estimation processing of estimating the hardness of the ground based on the weight of the earth detected by the weight detection unit and first hardness correspondence data defining a change in the weight of the earth due to a difference in the hardness of the ground after execution of a predetermined excavation operation in which the work attachment changes its posture while satisfying a target speed condition from an excavation start posture to an excavation completion posture capable of holding the earth after excavation.

### TECHNICAL FIELD

The present invention relates to a construction machine.

### BACKGROUND ART

Conventionally, there has been known a construction machine including a machine body and a work attachment supported by the machine body so as to be raised and lowered, and configured to be able to estimate hardness of ground. Patent Literature 1 discloses an example of such a construction machine. The construction machine includes a sensor including a strain sensor or an acceleration sensor attached to the work attachment, and a hardness estimation unit that estimates the hardness of the ground based on a detection value of the sensor.

The hardness estimation unit is configured to estimate the hardness of the ground based on a detection value of the sensor when a predetermined operation of bringing the work attachment into contact with the ground surface (ground) at a predetermined speed and a predetermined angle is performed and data in which the detection value of the sensor when the predetermined operation is performed and the hardness of the ground are associated with each other. Specifically, the hardness estimation unit is configured to determine a feature (for example, a feature such as whether the waveform is a waveform in which acceleration decreases in a short time after a large acceleration is indicated) of a waveform of a detection value by the sensor and estimate the hardness of the ground according to the determined feature of the waveform (see paragraphs [0054] to [0055] and the like of Patent Literature 1).

### CITATION LIST

### Patent Literature

Patent Literature 1: JP 7073151 B2

In the construction machine described in Patent Literature 1, since the feature of the waveform of the detection value by the sensor is determined when the hardness estimation unit estimates the hardness of the ground, there is a problem that arithmetic processing becomes complicated and the risk of erroneous determination increases (as a result, the estimation accuracy of the ground hardness decreases) as compared with the case of simply determining the magnitude relationship of the detection value.

In addition, in the construction machine described in Patent Literature 1, in order to estimate the hardness of the ground with high resolution, it is necessary to prepare data associated with the hardness of the ground by finely classifying the feature of the waveform of the detection value of the sensor according to the hardness of the ground. However, when the features of the waveform are finely classified, the accuracy of determination of the waveform in the hardness estimation unit is deteriorated, and accordingly, the estimation accuracy of the ground hardness in the hardness estimation unit is deteriorated.

### SUMMARY OF INVENTION

The present invention has been made to solve the above-described problems, and an object thereof is to provide a construction machine capable of estimating the hardness of the ground with high accuracy.

Provided according to the present invention is a construction machine including a machine body, a work attachment that is mounted to the machine body, includes a bucket capable of excavating and holding earth constituting ground, and is capable of executing an excavation operation of the ground through the bucket, a weight detection unit that is capable of detecting a weight of the earth held by the bucket, and a hardness estimation unit that estimates hardness of the ground. The hardness estimation unit is configured to execute estimation processing of estimating hardness of the ground based on a weight of the earth detected by the weight detection unit and first hardness correspondence data defining a change in weight of the earth due to a difference in hardness of the ground after execution of a predetermined excavation operation in which the work attachment changes its posture while satisfying a target speed condition from an excavation start posture to an excavation completion posture capable of holding earth after excavation.

### BRIEF DESCRIPTION OF DRAWINGS

FIG. 1 is a side view illustrating a construction machine according to a first embodiment.

FIG. 2 is a schematic diagram illustrating a hydraulic control circuit of a construction machine.

FIG. 3 is a block diagram illustrating a configuration of a control system of the construction machine.

FIG. 4A is an explanatory diagram for explaining a predetermined excavation operation by a work attachment, and is a diagram illustrating a state in which the work attachment is in an excavation start posture.

FIG. 4B is an explanatory diagram for explaining a predetermined excavation operation by the construction machine, and is a diagram illustrating a state in which a bucket of the work attachment is excavating earth from the ground.

FIG. 4C is an explanatory diagram for explaining a predetermined excavation operation by the construction machine, and is a diagram illustrating a state in which the work attachment is in an excavation completion posture.

FIG. 5 is a diagram illustrating dimensional information used in a moment balancing expression when a weight of earth held in the bucket is calculated by a weight detection unit.

FIG. 6 is a diagram illustrating an example of hardness correspondence data in which the weight of the earth held by the bucket by the predetermined excavation operation of the work attachment and the hardness of the ground are associated with each other.

FIG. 7A is an explanatory diagram for explaining that the excavation amount of earth by the bucket is different between soft soil and hard soil when the predetermined excavation operation is executed by the work attachment, and is a diagram illustrating with a broken line an excavation route when soft soil is excavated.

FIG. 7B is an explanatory diagram for explaining that the excavation amount of earth by the bucket is different between soft soil and hard soil when the predetermined excavation operation is executed by the work attachment, and is a diagram illustrating with a broken line an excavation route when hard soil is excavated.

FIG. 8 is an explanatory diagram for explaining how to determine a target speed condition (in this example, the target speed of the combined barycenter) when the predetermined excavation operation is executed by the work attachment.

FIG. 9 is a flowchart illustrating an example of hardness estimation processing executed by a controller.

FIG. 10 is a diagram corresponding to FIG. 3 illustrating a modification of the first embodiment.

FIG. 11 is a schematic diagram illustrating an example of a notification screen for notifying a deviation degree between a speed state of the work attachment and a target speed condition in a modification of the first embodiment.

FIG. 12 is a diagram corresponding to FIG. 3 illustrating a second embodiment.

FIG. 13 is a schematic diagram illustrating a temporal change of a cylinder load when a predetermined excavation operation is executed by the work attachment.

FIG. 14 is a diagram corresponding to FIG. 9 illustrating the second embodiment.

FIG. 15 is a diagram corresponding to FIG. 3 illustrating a third embodiment.

FIG. 16 is a diagram illustrating an example of operation data acquired by an operation data acquisition unit.

FIG. 17 is a diagram corresponding to FIG. 9 illustrating the third embodiment.

FIG. 18A is a graph illustrating an example of second hardness correspondence data.

FIG. 18B is a graph illustrating an example of second hardness correspondence data.

FIG. 18C is a graph illustrating an example of second hardness correspondence data.

FIG. 19 is a diagram illustrating an example of weight factor data defining a weight factor corresponding to each operating state correspondence hardness (second hardness).

FIG. 20 is a diagram illustrating an example of data of an acquisition result of the operating situation correspondence hardness.

FIG. 21 is a diagram illustrating an example of an information display screen.

FIG. 22 is a diagram corresponding to FIG. 6 illustrating another modification.

### DESCRIPTION OF EMBODIMENTS

A preferred embodiment of the present invention will be described below with reference to the drawings.

### First Embodiment

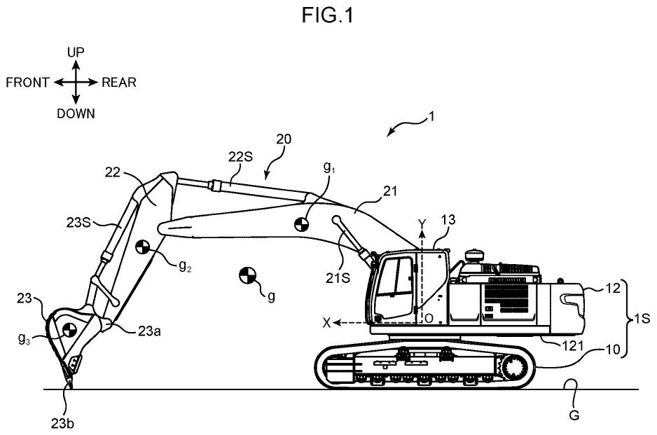

FIG. 1 is a side view illustrating a hydraulic excavator 1 (construction machine) according to a first embodiment of the present invention. The hydraulic excavator 1 includes a crawler-type lower traveling body 10 that can travel on a traveling surface (a ground surface G, and an upper surface of the ground), an upper slewing body 12 mounted on the lower traveling body 10 so as to be able to slew around the slewing center axis perpendicular to the traveling surface, and a work attachment 20 (work machine) mounted on the upper slewing body 12 to allow a derricking movement. The work attachment 20 includes a boom 21 supported by the upper slewing body 12 in a derrickable manner, an arm 22 pivotally connected to a distal end of the boom 21, and a bucket 23 (distal end member) pivotally connected to a distal end of the arm 22. The bucket 23 includes a proximal end portion 23a connected to the arm 22 and a distal end portion 23b on which a claw portion is formed when viewed from the side. The upper slewing body 12 includes a slewing frame 121 and a cab 13. The lower traveling body 10 and the upper slewing body 12 constitute a machine body 1S.

The hydraulic excavator 1 further includes a boom cylinder 21S that is actuated to cause the boom 21 to make a derricking movement with respect to the upper slewing body 12, an arm cylinder 22S that is actuated to cause the arm 22 to make a pivoting movement with respect to the boom 21, and a bucket cylinder 23S that is actuated to cause the bucket 23 to make a pivoting movement with respect to the arm 22. Each cylinder is actuated to expand and contract by receiving a hydraulic oil from a hydraulic pump.

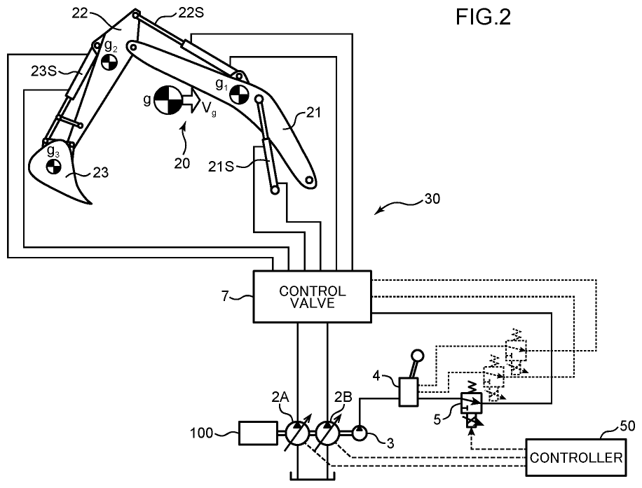

FIG. 2 is a schematic diagram illustrating a hydraulic control circuit of the construction machine. In FIG. 2, g1 represents the barycenter of the boom 21, g2 represents the barycenter of the arm 22, g3 represents the barycenter of the bucket 23, and g represents the combined barycenter of the work attachment 20.

The hydraulic excavator 1 further includes an engine 100, hydraulic first pump 2A and second pump 2B, a hydraulic pump 3 for pilot pressure oil, an operation unit 4, an electromagnetic proportional valve 5, a control valve 7, and a controller 50.

The engine 100 is controlled by an ECU 32 to be described later, receives a predetermined injection amount of fuel, and rotates. The first pump 2A and the second pump 2B are connected to an output shaft of the engine 100 and rotate upon receiving driving force of the engine 100. Each pump is a hydraulic pump and discharges the hydraulic oil for actuating the boom cylinder 21S, the arm cylinder 22S, and the bucket cylinder 23S.

The above-described boom cylinder 21S expands and contracts to cause the boom 21 to make a derricking movement (move) by receiving the supply of the hydraulic oil discharged from the first pump 2A. In the present embodiment, the boom cylinder 21S includes a cylinder body, and a cylinder rod that includes a piston portion that partitions the cylinder body into a head chamber and a rod chamber and is relatively movable with respect to the cylinder body. The distal end portion of the cylinder rod is connected to the boom 21 via a link mechanism (not shown). The boom cylinder 21S can expand to cause the boom 21 to stand up (boom raising movement) by receiving the hydraulic oil discharged from the first pump 2A into the head chamber via the control valve 7 and discharging the hydraulic oil from the rod chamber. Meanwhile, the boom cylinder 21S can contract to cause the boom 21 to fall down (boom lowering movement) by receiving the hydraulic oil discharged from the first pump 2A into the rod chamber via the control valve 7 and discharging the hydraulic oil from the head chamber. Note that the arm cylinder 22S and the bucket cylinder 23S also have the similar structure to the boom cylinder 21S.

The operation unit 4 includes a lever operated by an operator, and receives manual operation for moving the boom 21, the arm 22, and the bucket 23 of the work attachment 20. That is, the operation unit 4 includes a boom operation unit, an arm operation unit, and a bucket operation unit. In each manual operation, an operation direction and an operation amount are variable. Note that the operation unit 4 also accepts operations related to the slewing movement of the upper slewing body 12 and the traveling movement of the lower traveling body 10, and the like.

The control valve 7 is disposed to be interposed between each hydraulic pump and the boom cylinder 21S, and includes a spool that moves to change (control) the flow rate and flow path of the hydraulic oil supplied from each hydraulic pump to the boom cylinder 21S. Specifically, mainly when the boom 21 performs the boom raising movement and the boom lowering movement, the control valve 7 acts to supply the hydraulic oil of the hydraulic pump to the boom cylinder 21S and to discharge the hydraulic oil discharged from the boom cylinder 21S into a tank (not shown). The control valve 7 includes a pilot-operated three-position directional switching valve having one pair of pilot ports.

When the pilot pressure is input into none of the pair of pilot ports, the control valve 7 is maintained at the neutral position to shut off between the hydraulic pump and the boom cylinder 21S.

When the boom lowering pilot pressure is input into one pilot port, the control valve 7 is switched from the neutral position to the boom lowering position with a stroke corresponding to the magnitude of the boom lowering pilot pressure. This causes the control valve 7 to be opened to allow the hydraulic oil to be supplied from the hydraulic pump to the rod chamber of the boom cylinder 21S at a flow rate corresponding to the stroke, and allow the hydraulic oil to be discharged from the head chamber of the boom cylinder 21S. This causes the boom cylinder 21S to be driven in the boom lowering direction at a speed corresponding to the boom lowering pilot pressure.

When the boom raising pilot pressure is input into the other pilot port, the control valve 7 is switched from the neutral position to the boom raising position with a stroke corresponding to the magnitude of the boom raising pilot pressure. This causes the control valve 7 to be opened to allow the hydraulic oil to be supplied from the hydraulic pump to the head chamber of the boom cylinder 21S at a flow rate corresponding to the stroke, and allow the hydraulic oil to be discharged from the rod chamber of the boom cylinder 21S. This causes the boom cylinder 21S to be driven in the boom raising direction at a speed corresponding to the boom raising pilot pressure.

Note that the control valve 7 that performs the same movement as described above is disposed between each hydraulic pump and each of the arm cylinder 22S and the bucket cylinder 23S. The control valve 7 corresponding to the arm cylinder 22S can be switched to the arm pushing position, the neutral position, and the arm pulling position.

The electromagnetic proportional valve 5 is opened such that the pilot pressure (secondary pressure) corresponding to the operation input into the operation unit 4 acts on each pilot port of the control valve 7 by the pilot oil supplied from the hydraulic pump 3 for pilot pressure oil. The opening degree of the electromagnetic proportional valve 5 is adjusted by a proportional signal input from the controller 50. In another embodiment, a remote control valve (not illustrated) that opens according to the angle of the lever of the operation unit 4 may transmit the pressure to the control valve 7 as the secondary pressure. In this case, a proportional valve may be provided between the lever and the control valve 7, and the secondary pressure may be adjusted by the proportional valve before reaching the control valve 7.

As illustrated in FIG. 2, the boom cylinder 21S, the arm cylinder 22S, and the bucket cylinder 23S expand and contract by receiving the supply of hydraulic oil from the pumps 2A and 2B according to the operation amount that is the magnitude of the operation received by the operation unit 4. The boom cylinder 21S, the arm cylinder 22S, and the bucket cylinder 23S are supplied with the hydraulic oil from the pumps 2A and 2B through the control valve 7 that switches the direction of a supply oil. In FIG. 2, a hydraulic circuit for moving the work attachment 20 and the engine 100 are collectively defined as a drive unit 30. The controller 50 inputs a command signal to the drive unit 30 according to the operation amount. The controller 50 controls the drive of the work attachment 20 by controlling the hydraulic system illustrated in FIG. 2. The drive unit 30 has a function of moving each member of the work attachment 20 at a speed corresponding to a command signal (proportional signal) input to the electromagnetic proportional valve 5 to move the work attachment 20.

In the present embodiment, the controller 50 measures or calculates the speeds of the combined barycenters of the boom 21, the arm 22, and the bucket 23 constituting the work attachment 20, and determines (adjusts) a command signal for the electromagnetic proportional valve 5 that is a part of the drive unit 30 using feedback control so that the speed follows a predetermined target value (so as to satisfy a target speed condition).

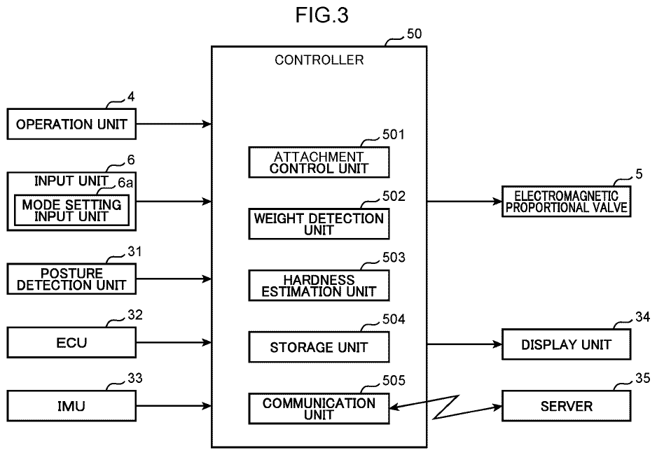

FIG. 3 is a block diagram illustrating a configuration of a control system of the hydraulic excavator 1. In the present embodiment, for example, the controller 50 is mounted in a cab on the upper slewing body 12 and controls the entire operation of the hydraulic excavator 1. The controller 50 is provided with a computer, and each function is implemented by the computer executing a program. The computer includes, as a main hardware configuration, a processor that acts according to the program. A type of the processor is not limited as long as a function can be implemented by executing a program, and the processor may be configured by, for example, one or a plurality of electronic circuits including a semiconductor integrated circuit (IC) or a large scale integration (LSI). The plurality of electronic circuits may be integrated on one chip or may be provided on a plurality of chips. The plurality of chips may be integrated into one device or may be provided in a plurality of devices. The program is recorded in a computer-readable non-transitory recording medium such as a ROM, an optical disk, or a hard disk drive. The program may be stored in advance in a recording medium, or may be supplied to the recording medium via a wide area communication network including the Internet or the like. Details of the functions implemented by the controller 50 will be described later.

The operation unit 4, an input unit 6, a posture detection unit 31, an engine control unit (ECU) 32, an inertial measurement unit (IMU) 33, a display unit 34, and the electromagnetic proportional valve 5 are connected to the controller 50 so as to be able to transmit and receive signals.

The input unit 6 is provided in the cab 13, and accepts input of information necessary for the control executed by the controller 50. The input unit 6 includes a mode setting input unit 6a. The mode setting input unit 6a includes a switch or the like manually operable by the operator, and is configured to be able to set the current operation mode to either the normal operation mode or the hardness estimation mode for estimating the hardness of the ground by operating the switch. The mode setting input unit 6a transmits the set mode information to the controller 50.

The posture detection unit 31 detects information regarding the posture of the work attachment 20. Specifically, the posture detection unit 31 acquires relative posture information of the work attachment 20 with respect to the upper slewing body 12. As one example, the posture detection unit 31 includes three sensors mounted on the boom cylinder 21S, the arm cylinder 22S, and the bucket cylinder 23S, and detects the stroke (expansion amount, length) of each cylinder. The stroke of each cylinder detected by each sensor is used to calculate the position and posture of the boom 21, the arm 22, and the bucket 23, and is further used to calculate the position and speed Vg (see FIG. 2) of a combined barycenter g of the work attachment 20. Note that in order to calculate the position and posture of the boom 21, the arm 22, and the bucket 23, an angle sensor that detects the pivoting angle of each of the boom 21, the arm 22, and the bucket 23 may be used instead of the cylinder stroke sensor.

The ECU 32 receives a rotation speed command signal from the controller 50 and controls the engine 100 so as to rotate the engine 100 by a fuel injection amount corresponding to the rotation speed command signal.

The IMU 33 detects information regarding the posture of the upper slewing body 12 with respect to the ground surface G. That is, the IMU 33 detects the posture angle (inclination) of the machine body 1S of the hydraulic excavator 1. As one example, the IMU 33 is mounted on the top of the cab 13.

The display unit 34 is a liquid crystal display provided in the cab 13, and displays various types of information such as the operating state of the hydraulic excavator 1 and the hardness of the ground estimated in the hardness estimation mode to notify the operator.

The controller 50 includes a central processing unit (CPU), a read only memory (ROM) that stores a control program, random access memory (RAM) used as a work area for the CPU, and the like. The controller 50 includes an attachment control unit 501, a weight detection unit 502, a hardness estimation unit 503, a storage unit 504, and a communication unit 505. The attachment control unit 501, the weight detection unit 502, and the hardness estimation unit 503 are functional units implemented by the CPU executing the control program, the storage unit 504 is a functional unit implemented by a non-transitory recording medium such as a ROM or a hard disk, for example, and the communication unit 505 is a functional unit implemented by a wireless communication device having a wireless LAN chip, for example. All or a part of the controller 50 is not limited to those provided in the hydraulic excavator 1, and may be disposed at a position different from the hydraulic excavator 1 in a case where the hydraulic excavator 1 is remotely controlled. The control program may be transmitted from a server (which may be a server 35 described later), a cloud, or the like at a remote location to the controller 50 in the hydraulic excavator 1 and executed, or the control program may be executed on the server or the cloud and various command signals generated may be transmitted to the hydraulic excavator 1.

When the operator operates the operation unit 4 to cause the work attachment 20 to execute a predetermined excavation operation, the attachment control unit 501 calculates the combined barycenter speed Vg of the work attachment 20 based on the information from the posture detection unit 31, and executes feedback control for adjusting the boom input to the electromagnetic proportional valve 5 so that the calculated combined barycenter speed Vg follows (approaches) a target barycenter speed r. The attachment control unit 501 functions as a speed state detection unit and a control unit of the present invention.

Specifically, as illustrated in FIGS. 1 and 2, with a pivoting proximal end of the boom 21 of the work attachment 20 as origin 0, the Y coordinates are defined in the perpendicular direction, the X coordinates are defined in the horizontal direction, the mass of the boom 21 is defined as m1, the coordinates of the barycenter g1 of the boom 21 are defined as (x1(t), y1(t)), the mass of the arm 22 is defined as m2, the coordinates of the barycenter g2 of the arm 22 are defined as (x2(t), y2(t)), the mass of the bucket 23 is defined as m3, and the coordinates of the barycenter g3 of the bucket 23 are defined as (x3(t), y3(t)). Note that each coordinate, which varies as the work attachment 20 moves, is represented as a variable of time t. In this case, the coordinates (xg(t), yg(t)) of the combined barycenter g of the work attachment 20 can be expressed by the following Expression 1.

$$\begin{matrix}[ Math . 1 ] & \\ ( {X}_{g} ( t ) , {Y}_{g} ( t ) ) = ( \frac{{\sum }_{i = 1}^{3} {m}_{i} {x}_{i} ( t )}{{m}_{1} + {m}_{2} + {m}_{3}} , \frac{{\sum }_{i = 1}^{3} {m}_{i} {y}_{i} ( t )}{{m}_{1} + {m}_{2} + {m}_{3}} ) & ( Expression 1 )\end{matrix}$$

Further, when Expression 1 is used, the speed Vg(t) of the combined barycenter g can be expressed by the following Expression 2.

$$\begin{matrix}[ Math . 2 ] & \\ {V}_{g} ( t ) = \sqrt{\frac{{{dX}_{g} ( t )}^{2}}{dt} + \frac{{{dY}_{g} ( t )}^{2}}{dt}} & ( Expression 2 )\end{matrix}$$

The attachment control unit 501 adjusts an input u(t) of the boom operation at the time of a predetermined excavation operation so that the combined barycenter speed Vg(t) follows the target barycenter speed r(t). The input u(t) corresponds to a proportional signal input to the electromagnetic proportional valve 5, and is expressed by the following Expression 3. Here, a proportional integral differential (PID) control law can be used as an adjustment law of the input u(t). Note that uh(t) is a boom operation variable by the operator, and uc(t) is a boom operation variable set by the attachment control unit 501 of the controller 50.

$$\begin{matrix}[ Math . 3 ] & \\ u ( t ) = {u}_{h} ( t ) + {u}_{c} ( t ) & ( Expression 3 )\end{matrix}$$

$$\begin{matrix}[ Math . 4 ] & \\ {u}_{c} ( t ) = {u}_{c} ( t - 1 ) + {K}_{p 1} ( t ) Δ e ( t ) + {K}_{i 1} e ( t ) + {K}_{d 1} {Δ}^{2} e ( t ) & ( Expression 4 )\end{matrix}$$

$$\begin{matrix}[ Math . 5 ] & \\ e ( t ) := r ( t ) - {V}_{g} ( t ) & ( Expression 5 )\end{matrix}$$

Here, in the PID control law expressed by Expression 4, Kp1 denotes a proportional gain, Ki1 denotes an integral gain, and Kd1 denotes a derivative gain, and the input uc(t), that is, the boom operation variable is adjusted according to a control deviation e(t) expressed by Expression 5.

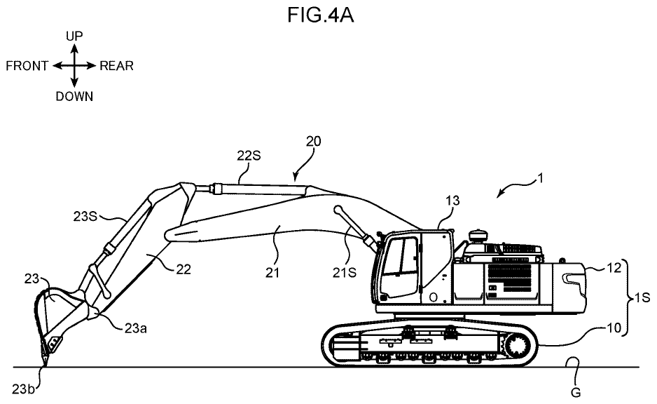

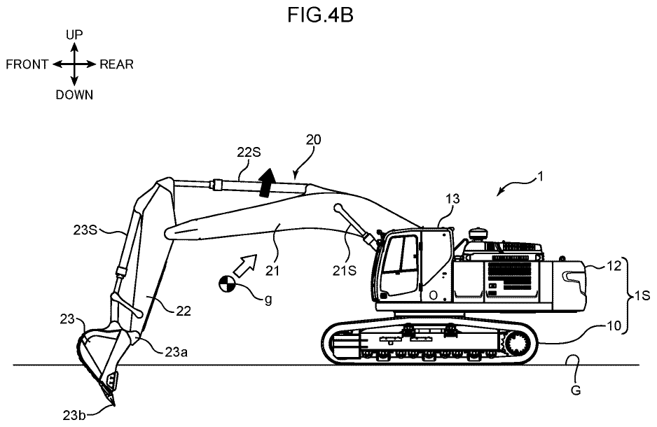

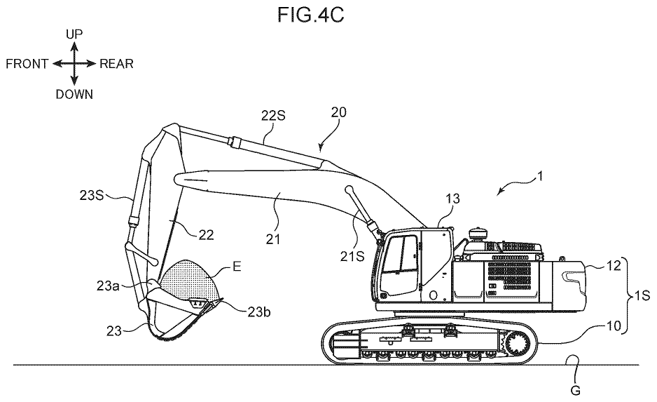

The predetermined excavation operation is an excavation operation of changing the posture of the work attachment 20 from a predetermined excavation start posture to an excavation completion posture so as to satisfy a target speed condition (in the present example, the condition that the combined barycenter speed Vg of the work attachment 20 is constant (=target barycenter speed r)). FIGS. 4A to 4C are explanatory diagrams for explaining the predetermined excavation operation, in which FIG. 4A illustrates a state in which the work attachment 20 is in the excavation start posture, FIG. 4B illustrates a state in which the bucket 23 of the work attachment 20 is excavating earth from the ground, and FIG. 4C illustrates a state in which the work attachment 20 is in the excavation completion posture.

The excavation start posture is, for example, a posture in which the boom 21 and the arm 22 are in the maximum reach posture in which the horizontal lengths of the boom 21 and the arm 22 are the longest (state in which the boom cylinder 21S and the arm cylinder 22S are extended the most) and the diagonal angle of the bucket 23 (angle formed by the distal end portion 23b (claw) of the bucket 23 and the ground surface G) is, for example, 70° to 120° (see FIG. 4A). When the predetermined excavation operation is started from the excavation start posture, the tilt angle of the boom 21 increases and the arm 22 rotates so as to approach the boom 21, and the bucket 23 rotates in the counterclockwise direction in the drawing with the proximal end portion 23a as a fulcrum (see FIG. 4B). As a result, the entire bucket 23 pivots with the proximal end portion 23a as a fulcrum while the distal end portion 23b of the bucket 23 penetrates (enters) the ground surface, and earth constituting the ground excavated at the distal end portion 23b of the bucket 23 is guided into the bucket 23. At this time, the operation of the boom 21 is controlled by the controller 50 so that the speed Vg of the combined barycenter g of the work attachment 20 is maintained at the target barycenter speed r (see the black arrow in FIG. 4B). Then, after the bucket 23 rotates and the distal end portion 23b comes out of the ground surface, the posture shifts to the excavation completion posture (see FIG. 4C). In the excavation completion posture, the opening of the bucket 23 faces upward, and the excavated earth E is held by the bucket 23.

The weight detection unit 502 detects (calculates) the weight of the earth held by the bucket 23 based on the detection information by the posture detection unit 31. The “weight” includes both the meaning of “mass” and the meaning of “load”, and may have any meaning. That is, the weight detection unit 502 may detect the mass of earth or may detect a load. In (Expression 6) described later in the present embodiment, the mass of earth is calculated as an example.

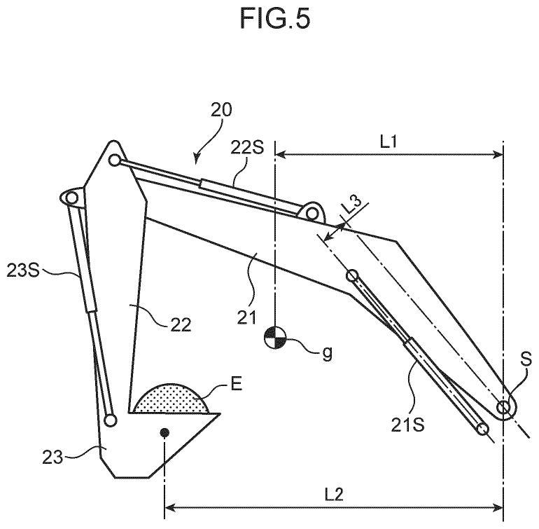

The weight detection unit 502 calculates the weight of the earth from the balancing expression of the moments around the rotation fulcrum S of the proximal end portion of the boom 21 based on the previously stored dimensional information and weight information of the work attachment 20, the load of the boom cylinder 21S measured by a sensor (for example, a load cell or a pressure sensor) (not illustrated), and the posture of the work attachment 20 detected by the posture detection unit 31. FIG. 5 is a diagram illustrating dimensional information used in the moment balancing expression, in which the horizontal distance between the combined barycenter g of the work attachment 20 and the rotation fulcrum S in the excavation completion posture is L1, the horizontal distance between the barycenter position of earth (assumed to be the central position in front of and behind the bucket 23) and the rotation fulcrum S is L2, and the distance between the axis of the boom cylinder 21S and the rotation fulcrum S is L3. Here, assuming that the thrust of the boom cylinder 21S is F1 (N), the weight of the work attachment 20 (cylinder weight or the like is not included here because it can be ignored as an example) is F2 (kg), and the weight of the earth E held by the bucket 23 is X (kg), the weight X (kg) of the earth is expressed by the following Expression 6 based on the balance of the moments. The weight detection unit 502 calculates the weight (in this example, the mass) of the earth held by the bucket 23 by performing calculation based on Expression 6.

$$X = ( F 1 * L 3 - F 2 * g * L 1 ) / ( g * L 2 ) \qquad ( Expression 6 )$$

Note that “g” included in Expression 6 is gravitational acceleration and does not mean the above-described combined barycenter.

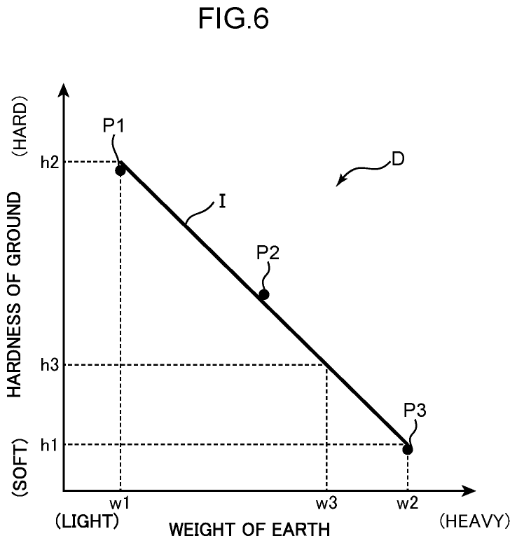

When the hardness estimation mode is set by the mode setting input unit 6a, after the above-described predetermined excavation operation by the work attachment 20 is executed, the hardness estimation unit 503 estimates the hardness of the ground based on the weight of the earth E on the bucket 23 detected by the weight detection unit 502, and the hardness correspondence data D (see FIG. 6 to be described later) in which the weight of the earth E and the hardness of the ground are associated with each other.

The storage unit 504 stores parameters and thresholds required in various processing executed by the controller 50. In addition, the storage unit 504 stores the hardness correspondence data D in which the weight of the earth E excavated and held by the bucket 23 and the hardness of the ground are associated with each other by execution of the predetermined excavation operation by the work attachment 20.

FIG. 6 is a diagram illustrating an example of the hardness correspondence data D. In the hardness correspondence data D, the relationship between the weight of the earth E held by the bucket 23 and the hardness of the ground is defined by a linear first-order approximate straight line I. In this example, the hardness correspondence data D is graph data in which the weight of the earth E held by the bucket 23 is taken on the horizontal axis and the hardness of the ground is taken on the vertical axis, but the data format is not limited thereto, and may be, for example, table data. It can also be said that the hardness correspondence data D is data that defines a change in the weight of the earth E due to a difference in the hardness of the ground.

The hardness of the ground on the vertical axis can be represented by, for example, a penetration resistance value by a penetration test using a cone penetrometer or an N value measured by a sounding test, but is not limited thereto, and may be represented by, for example, a shear strength obtained by a shear strength test, or may be represented by a hardness level divided stepwise as described in another embodiment to be described later.

The hardness correspondence data D is created, for example, based on an excavation test performed in advance by a manufacturer before market shipment of the hydraulic excavator 1. In this excavation test, for example, the above-described predetermined excavation operation by the work attachment 20 is executed for a plurality of types of ground having different hardness. At this time, the ground on which the hydraulic excavator 1 is disposed is preferably a horizontal ground surface without inclination. The predetermined excavation operation by the work attachment 20 is performed by the operator operating the operation unit 4 so as to satisfy the target speed condition (in the present example, the combined barycenter speed Vg of the work attachment 20 becomes constant (=target barycenter speed r)). At this time, it is preferable to turn on (enable) the feedback control function (the adjustment function of the boom input to the electromagnetic proportional valve 5) by the attachment control unit 501 described above. Then, when the predetermined excavation operation is performed on a plurality of types of ground having different hardness (in this example, three types corresponding to the three data points P1 to P3 in FIG. 6), the weight of the earth E excavated and held by the bucket 23 is detected by the weight detection unit 502. Then, a plurality of data points P1 to P3 in which the detected weight of the earth E and the hardness of the ground are associated with each other are plotted on a coordinate plane, and an approximate straight line I most suitable for the plurality of data points P1 to P3 is calculated using an approximate method such as a least squares method, whereby the hardness correspondence data D illustrated in FIG. 6 can be obtained. In the present example, the three data points P1 to P3 are used, but the number is not limited to three, and may be two or more. The approximation of the data points is not necessarily a straight line, and may be a quadratic or higher approximate curve.

The communication unit 505 transmits information on the hardness of the ground estimated by the hardness estimation unit 503 to the server 35 (an example of a management device). The information on the hardness of the ground transmitted to the server 35 can be browsed from, for example, another external terminal (for example, a personal computer, a smartphone, or the like) configured to be communicable with the server 35, and is used for review of a construction plan, management of a construction history, and the like.

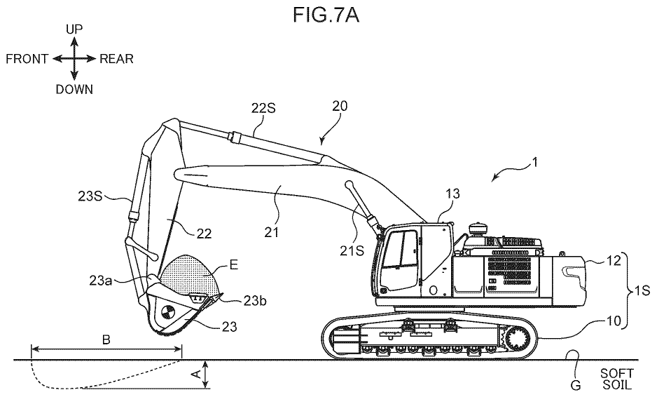

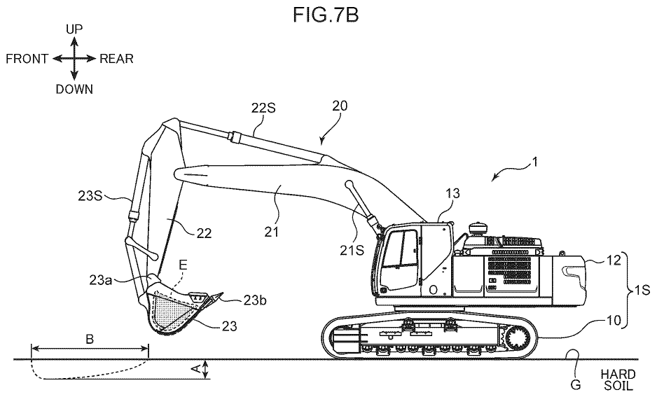

Meanwhile, in the above-described hardness correspondence data D (see FIG. 6), characteristics are shown in which the weight of the earth E excavated and held by the bucket 23 decreases when the hardness of the ground is hard, and the weight of the earth E excavated and held by the bucket 23 increases when the hardness of the ground is soft, but such characteristics are knowledge obtained by earnest research such as the invention, and the reason why such characteristics can be obtained will be described below with reference to FIGS. 7A and 7B.

FIGS. 7A and 7B are schematic diagrams illustrating the excavation route of the bucket 23 when the predetermined excavation operation is executed by the work attachment 20 by broken lines.

In the predetermined excavation operation for hard soil illustrated in FIG. 7B, it can be seen that the depth A of the excavation route (a route indicated by the broken line) by the bucket 23 from the ground surface is shallower than that in the predetermined excavation operation for soft soil in FIG. 7A. That is, as in the present embodiment, in a case where excavation is performed while the combined barycenter speed Vg of the work attachment 20 is kept constant regardless of the hardness of the ground (in a case where the predetermined excavation operation satisfying the target speed condition is executed), the excavation resistance acting on the bucket 23 becomes higher in hard soil than in soft soil, and thus the speed of the arm 22 decreases early. Therefore, in order to compensate for the decrease in the combined barycenter speed Vg of the work attachment 20 due to the speed decrease of the arm 22 (in order to cause the combined barycenter speed Vg to follow the target barycenter speed r), the boom 21 is pivoted in the clockwise direction in the drawing to pull up the distal end of the boom 21 (see the black arrow in FIG. 4B described above). As a result, the excavation resistance acting on the bucket 23 decreases and the combined barycenter speed Vg follows the target barycenter speed r, but at this time, the excavation locus of the bucket 23 is shifted upward as a whole. As a result, in the hard soil, since the excavation depth A by the bucket 23 becomes shallower and the excavation distance B in the front-rear direction (the left-right direction in FIGS. 7A and 7B) becomes shorter than that in the soft soil, the weight of the earth E held by the bucket 23 also becomes small (see FIG. 7B).

In the present embodiment, focusing on the fact that the weight of the earth E held by the bucket 23 changes after completion of the excavation operation by performing the predetermined excavation operation so as to maintain the combined barycenter speed Vg of the work attachment 20 constant (=target barycenter speed r) in this manner, the hardness of the ground is estimated based on the above-described hardness correspondence data D in which the weight of the earth E and the hardness of the ground are associated with each other. Then, in the case of estimating the hardness of the ground based on the weight of the earth E held by the bucket 23 as described above, the inventors have reached the idea that it is preferable that the weight of the earth held by the bucket 23 is clearly different between the case of excavating the hard ground and the case of excavating the soft ground from the viewpoint of improving the estimation accuracy, and devise the setting of the target barycenter speed r to enable this.

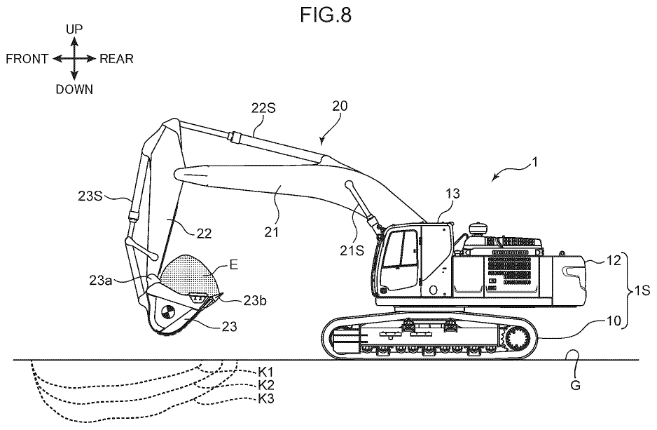

FIG. 8 is an explanatory diagram for describing a setting procedure of the target barycenter speed r. When the target barycenter speed r is set, for example, the ground corresponding to the softest hardness h1 (an example of predetermined hardness) in the hardness range (range of h1 to h2 in FIG. 6) defined in the hardness correspondence data D is prepared, the target barycenter speed r is changed in a plurality of stages (in the example of FIG. 8, as an example, there are three stages of high speed, medium speed, and low speed) with respect to the ground, and the predetermined excavation operation by the work attachment 20 is executed for each target barycenter speed. In FIG. 8, broken lines K1, K2, and K3 indicate the excavation locus of the bucket 23 when the target barycenter speed r is high speed, medium speed, and low speed, respectively. As can be seen from FIG. 8, the excavation locus of the bucket 23 changes for each target barycenter speed r. Specifically, in the example of FIG. 8, in the excavation locus K1 in which the target barycenter speed r corresponds to a high speed, the excavation amount of the earth excavated by the bucket 23 falls below the maximum loading amount that can be held in the bucket 23, and in the excavation locus K3 in which the target barycenter speed r corresponds to a low speed, the excavation amount of the earth excavated by the bucket 23 exceeds the maximum loading amount of the bucket 23 (a part of the earth spills out from the bucket 23), whereas in the excavation locus K2 in which the target barycenter speed r corresponds to a medium speed, the excavation amount of the earth excavated by the bucket 23 becomes an amount corresponding to the maximum loading amount of the bucket 23. Here, the “amount corresponding to the maximum loading amount” is not limited to a case where the excavation amount of earth is exactly the same value as the maximum loading amount, and may include an error up or down. In the present embodiment, by actually performing the excavation test in this way, the target barycenter speed r at which the excavation amount of the earth excavated by the bucket 23 becomes the amount corresponding to the maximum loading amount is found, and the target barycenter speed r is set as the target barycenter speed r of the work attachment 20 at the time of setting the hardness estimation mode. The target barycenter speed r thus set is stored in the storage unit 504 and used as the target barycenter speed r of the work attachment 20 described above. According to this, when the work attachment 20 is caused to execute the predetermined excavation operation to excavate the soft soil ground and the hard soil ground, respectively, the weight of the earth E excavated and held by the bucket 23 can be greatly different between the soft soil and the hard soil. Therefore, the hardness estimation processing of the present embodiment based on the weight of the earth E excavated and held by the bucket 23 can be executed with high accuracy.

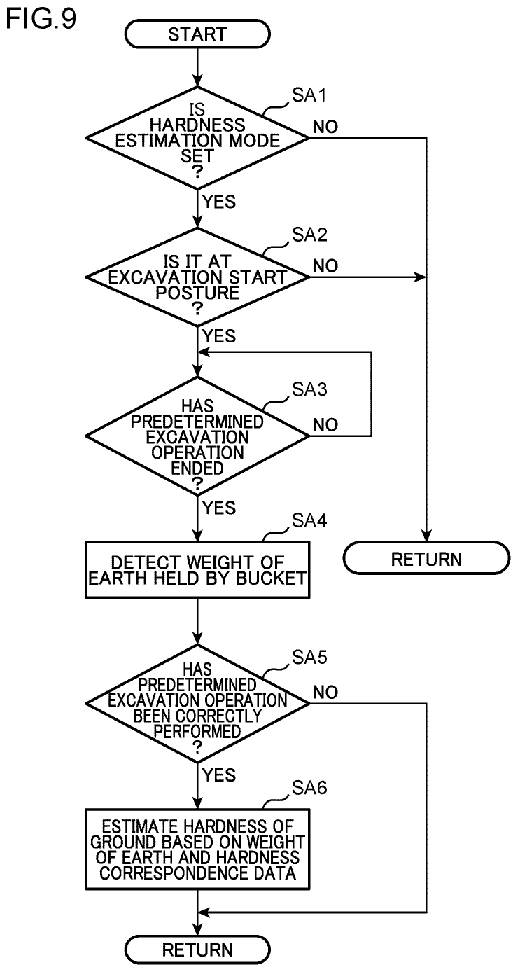

FIG. 9 is a flowchart illustrating contents of hardness estimation processing executed by the controller 50.

In step SA1, the hardness estimation unit 503 determines whether the hardness estimation mode is set as the operation mode of the hydraulic excavator 1 at the present time based on the mode setting information from the mode setting input unit 6a. When the hardness estimation unit 503 determines that the hardness estimation mode is not set (NO in step SA1), the process returns. On the other hand, when the hardness estimation mode is set (YES in step SA1), the process proceeds to step SA2.

In step SA2, the hardness estimation unit 503 determines whether the work attachment 20 is in the excavation start posture (see FIG. 4A) based on the posture information of the work attachment 20 detected by the posture detection unit 31. In a case where it is determined that the work attachment 20 is not in the excavation start posture (NO in step SA2), it is estimated that the operation for the predetermined excavation operation by the operator is not performed, and the procedure returns. On the other hand, when the hardness estimation unit 503 determines that the work attachment 20 is in the excavation start posture (YES in step SA2), the process proceeds to step SA3 since it is estimated that the operation for the predetermined excavation operation by the operator has started.

In step SA3, the hardness estimation unit 503 determines whether the work attachment 20 is in the excavation completion posture (see FIG. 4C) based on the posture information of the work attachment 20 detected by the posture detection unit 31. In a case where it is determined that the posture of the work attachment 20 is not in the excavation completion posture (NO in step SA3), it is estimated that the work attachment 20 is in the middle of executing the predetermined excavation operation, and the determination processing of step SA3 is repeatedly executed until the predetermined excavation operation is completed. On the other hand, in a case where it is determined that the work attachment 20 is in the excavation completion posture (YES in step SA3), it is estimated that the predetermined excavation operation is completed, and the process proceeds to step SA4.

In step SA4, the weight detection unit 502 detects the weight of the earth E held by the bucket 23.

In step SA5, the hardness estimation unit 503 determines whether the predetermined excavation operation by the work attachment 20 is correctly executed. That is, for example, when the work attachment 20 is displaced without satisfying the target speed condition due to an operation error or the like of the operator, the weight of the earth E excavated and held by the bucket 23 (that is, the weight of the earth E detected in step SA4) may not satisfy the assumed weight range of the earth E (for example, the range of the minimum earth weight w1 to the maximum earth weight w2 of the hardness correspondence data D (see FIG. 6)), and in such a case, it is determined that the predetermined excavation operation is not correctly executed. Examples of the incorrect predetermined excavation operation include an empty excavation state in which the bucket 23 rotates in the air. Note that it is not always necessary to determine whether the predetermined excavation operation has been correctly performed based on the weight of the earth E held by the bucket 23. For example, the determination may be made based on whether the time waveform of the cylinder load (for example, the load of the bucket cylinder 23S) after the start of the excavation operation deviates from a predetermined reference waveform by a predetermined amount or more. Then, in the determination processing of this step SA5, in a case where the hardness estimation unit 503 determines that the predetermined excavation operation by the work attachment 20 has not been correctly performed, the process returns. On the other hand, in a case where the hardness estimation unit 503 determines that the predetermined excavation operation has been correctly performed, the process proceeds to step SA6.

In step SA6, the hardness of the ground is estimated based on the weight of the earth E on the bucket 23 detected by the weight detection unit 502 in step SA4 and the hardness correspondence data D (see FIG. 6) stored in the storage unit 504. As an example, for example, when the weight of the earth E detected by the weight detection unit 502 is w3 (see FIG. 6), the hardness estimation unit 503 calculates (estimates) hardness h3 obtained by substituting the weight w3 into an approximate expression representing the approximate straight line I of the hardness correspondence data D as the hardness of the ground.

[Operation and effect of first embodiment] As described above, in the present embodiment, the hydraulic excavator 1 includes the weight detection unit 502 capable of detecting the weight of the earth E held by the bucket 23 and the hardness estimation unit 503 for estimating the hardness of the ground, and when estimating the hardness of the ground, the hardness estimation unit 503 is configured to estimate the hardness of the ground based on the weight of the earth E detected by the weight detection unit 502 and the hardness correspondence data D defining the change in the weight of the earth E due to the difference in the hardness of the ground after the predetermined excavation operation is executed in which the work attachment 20 changes its posture while satisfying the target speed condition from the excavation start posture to the excavation completion posture capable of holding the earth E after excavation.

According to this configuration, it is possible to reduce the risk of erroneous determination and improve the estimation accuracy of the ground as compared with the case where the features of the detection waveform of the sensor are determined by complicated arithmetic processing as in the related art. In addition, according to the present configuration, the earth weight defined in the hardness correspondence data D and the hardness of the ground are associated using the approximate straight line I, whereby the hardness of the ground can be estimated with high resolution. Moreover, according to the present configuration, since the predetermined excavation operation can be incorporated into the normal excavation operation performed by the work attachment 20 and the ground hardness can be estimated by the hardness estimation unit 503, a dedicated operation only for estimating the ground hardness is unnecessary, and the excavation operation by the work attachment 20 can be efficiently performed.

In the present embodiment, the target speed condition when the work attachment 20 executes the predetermined excavation operation is a condition that the combined barycenter speed of the boom 21, the arm 22, and the bucket 23 constituting the work attachment 20 is constant (=target barycenter speed).

In this configuration, focusing on the fact that the excavation operation by the work attachment 20 is performed by cooperation of the boom 21, the arm 22, and the bucket 23, when the hardness estimation unit 503 estimates the hardness of the ground, the work attachment 20 is caused to execute the predetermined excavation operation so that the combined barycenter speed Vg of the boom 21, the arm 22, and the bucket 23 becomes constant, whereby the excavation of the ground by the bucket 23 can be stably (uniformly) executed. Therefore, since the reproducibility of the earth weight held by the bucket 23 after the predetermined excavation operation (the reproducibility of the earth weight when the excavation operation is performed on the ground having the same hardness under the same speed condition) is secured, the estimation accuracy of the ground hardness by the hardness estimation unit 503 can be improved.

In the present embodiment, the controller 50 is configured to calculate (detect) the combined barycenter speed Vg of the boom 21, the arm 22, and the bucket 23 constituting the work attachment 20 during the execution of the predetermined excavation operation by the work attachment 20, determine a command signal to the drive unit 30 (specifically, the electromagnetic proportional valve 5 of the drive unit 30) so that the speed Vg follows the target barycenter speed r (so as to satisfy the target speed condition), and transmit the determined command signal to the drive unit 30.

According to this configuration, it is possible to prevent the combined barycenter speed Vg of the work attachment 20 from separating from the target barycenter speed r due to variations in operator's manual operation or the like, and to stabilize the operation of the work attachment 20.

In the present embodiment, the target barycenter speed r (an example of the target speed condition) of the work attachment 20 is set such that the excavation amount of the earth excavated by the bucket 23 becomes an amount corresponding to the maximum loading amount that can be held by the bucket 23 when the softest ground (an example of predetermined hardness) defined in the hardness correspondence data D is excavated by the predetermined excavation operation of the work attachment 20.

According to this configuration, the weight of the earth E held by the bucket 23 by the predetermined excavation operation of the work attachment 20 can be greatly different between the case where the ground is soft soil and the case where the ground is hard soil, and accordingly, the estimation accuracy of the ground hardness by the hardness estimation unit 503 can be improved.

Further, in the present embodiment, the hardness estimation unit 503 is configured to determine whether the predetermined excavation operation is correctly executed when the predetermined excavation operation by the work attachment 20 is executed, and not to execute the estimation processing of the ground hardness when it is determined that the predetermined excavation operation is not correctly executed.

According to this configuration, when the predetermined excavation operation by the work attachment 20 is not correctly executed, the estimation processing by the hardness estimation unit 503 is not executed, so that erroneous estimation of the ground hardness by the hardness estimation unit 503 can be prevented.

Furthermore, in the present embodiment, the hydraulic excavator 1 includes the communication unit 505, and the communication unit 505 is configured to receive information on the ground hardness estimated by the hardness estimation unit 503 and transmit the received information on the hardness to the server 35 provided at a place distant from the hydraulic excavator 1.

According to this configuration, the information on the hardness of the ground transmitted from the communication unit 505 to the server 35 can be used for reviewing a construction plan, managing a construction history, and the like.

### (Modification of First Embodiment)

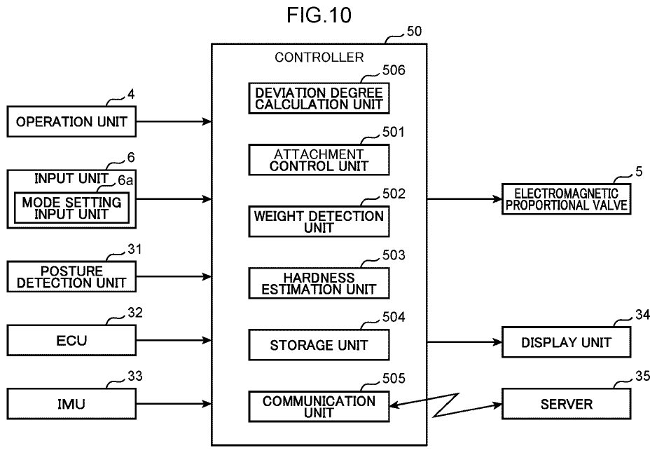

FIG. 10 is a diagram corresponding to FIG. 3 illustrating a modification of the first embodiment. This modification is different from the first embodiment in that the controller 50 further includes a deviation degree calculation unit 506, and the deviation degree between the combined barycenter speed Vg of the work attachment 20 calculated by the deviation degree calculation unit 506 and the target barycenter speed r is displayed on the display unit 34. In the following modifications and embodiments, the same components as those of the first embodiment are denoted by the same reference numerals, and the detailed description thereof will be omitted.

The deviation degree calculation unit 506 acquires the combined barycenter speed Vg of the work attachment 20 during the execution of the predetermined excavation operation by the work attachment 20 from the work attachment control unit 501, and calculates the deviation degree between the acquired combined barycenter speed Vg and the target barycenter speed r. Here, the deviation degree may be, for example, a value of a differential speed between the combined barycenter speed Vg and the target barycenter speed r, or may be a level of magnitude of the combined barycenter speed Vg based on the target barycenter speed. In the present modification, the deviation degree calculation unit 506 adopts the latter, and calculates a level of magnitude of the combined barycenter speed based on the target speed as the deviation degree.

Then, the deviation degree calculation unit 506 causes the display unit 34 to display a notification screen 34a for notifying the calculated information regarding the deviation degree, thereby visually notifying the operator of the deviation degree. The display unit 34 functions as a notification unit.

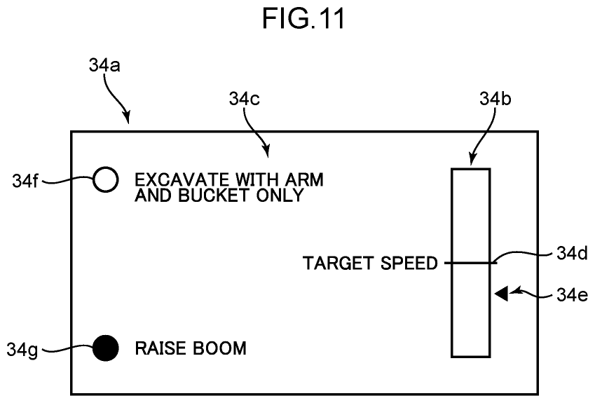

FIG. 11 is a schematic diagram illustrating an example of the notification screen 34a displayed on the display unit 34. The notification screen 34a displays a deviation degree display meter 34b and an operation message region 34c.

The deviation degree display meter 34b is a rectangular level meter that is long in the vertical direction, and is divided into a region above and a region below a reference line 34d corresponding to the target barycenter speed. A region above the reference line 34d in the deviation degree display meter 34b means that the combined barycenter speed Vg of the work attachment 20 is faster than the target barycenter speed r, and the combined barycenter speed Vg is faster toward the upper side (that is, the deviation degree from the target barycenter speed r is larger). In addition, a region below the reference line 34d in the deviation degree display meter 34b means that the combined barycenter speed Vg of the work attachment 20 is slower than the target barycenter speed r, and the combined barycenter speed Vg is slower toward the lower side (that is, the deviation degree from the target barycenter speed r is larger).

A triangular indication mark 34e is displayed on the right side of the deviation degree display meter 34b, and the deviation degree between the current combined barycenter speed Vg and the target barycenter speed r is notified to the operator by indicating the level of the current combined barycenter speed Vg with the vertex of the indication mark 34e.

The operation message region 34c is a region for notifying the operator of the operation required for reducing the deviation degree between the combined barycenter speed Vg of the work attachment 20 and the target barycenter speed r (for bringing the combined barycenter speed close to the target barycenter speed) in a message format.

Specifically, in the operation message region 34c, an instruction message “excavate only with the arm and the bucket” and an instruction message “raise the boom” are displayed side by side in two rows. Check boxes 34f and 34g are displayed on the left side of each message, and among the two check boxes 34f and 34g, check boxes corresponding to operations required of the operator are displayed with black circles.

In the example of FIG. 11, since the indication mark 34e indicates a region below the reference line 34d in the deviation degree display meter 34b, it can be seen that the combined barycenter speed Vg of the work attachment 20 is lower than the target barycenter speed r. Then, in a situation where the combined barycenter speed Vg is lower than the target barycenter speed r as described above, it is necessary to raise the boom 21 (increase the tilt angle) to bring the combined barycenter speed Vg close to the target barycenter speed r as described in the description of FIGS. 7A and 7B. Therefore, in the operation message region 34c of the notification screen 34a, the check box 34g corresponding to the instruction message “raise the boom” is displayed with a black circle. Therefore, the operator can recognize that the operation for raising the boom 21 is necessary by looking at the state (checked state) in which the check box 34g is displayed with a black circle.

### (Operation and Effect of Modification of First Embodiment)

As described above, in the present modification, the hydraulic excavator 1 includes the work attachment control unit 501 that detects the combined barycenter speed Vg (an example of the speed state) during the execution of the predetermined excavation operation of the work attachment 20, the deviation degree calculation unit 506 that calculates the information regarding the deviation degree between the combined barycenter speed Vg detected by the work attachment control unit 501 and the target barycenter speed r, and the display unit 34 (an example of the notification unit) that displays the information regarding the deviation degree calculated by the deviation degree calculation unit 506. The notification screen 34a including information related to the deviation degree is displayed on the display unit 34.

According to this configuration, during execution of the predetermined excavation operation by the work attachment 20, the operator can recognize how much the combined barycenter speed Vg of the work attachment 20 deviates from the target barycenter speed r by viewing the notification screen 34a displayed on the display unit 34. Then, based on the recognition, the operator can correct his/her manual operation so that the combined barycenter speed Vg of the work attachment 20 becomes the target barycenter speed r. Therefore, it is possible to prevent the combined barycenter speed Vg of the work attachment 20 from varying due to the manual operation of the operator. In addition, the reproducibility of the weight of the earth E excavated and held by the bucket 23 by the predetermined excavation operation by the work attachment 20 can be improved, and the estimation accuracy of the ground hardness by the hardness estimation unit 503 can be further improved.

Furthermore, in the present modification, the notification unit is configured by the display unit 34 that visually notifies the information regarding the deviation degree calculated by the deviation degree calculation unit 506, but the present invention is not limited thereto. For example, the notification unit may be configured to notify the operator of the information regarding the deviation degree through hearing using a speaker or the like.

### Second Embodiment

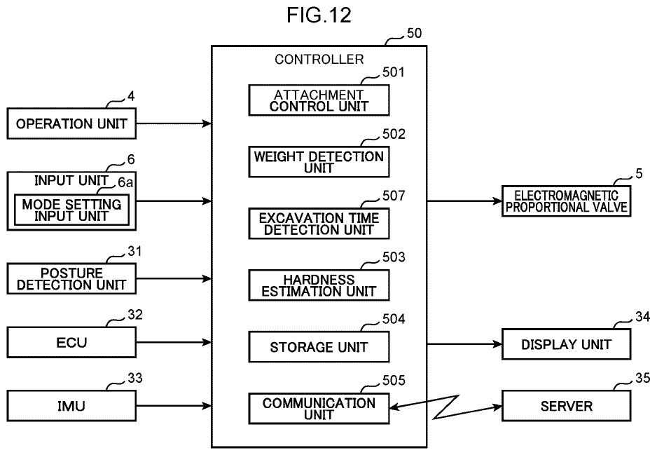

FIG. 12 is a diagram corresponding to FIG. 3 illustrating a second embodiment. This embodiment is different from the first embodiment in that the controller 50 further includes an excavation time detection unit 507, and the estimation processing of the ground hardness based on the weight of the earth E detected by the weight detection unit 502 and the estimation processing of the ground hardness based on the excavation time detected by the excavation time detection unit 507 are used in combination.

The excavation time detection unit 507 detects a time (that is, the time from the excavation start posture to the excavation completion posture after the excavation operation is started) required for the predetermined excavation operation by the work attachment 20. As an example, the excavation time detection unit 507 detects the time required for the predetermined excavation operation based on a temporal change of the cylinder load. As the cylinder load, any one of the load of the boom cylinder 21S, the load of the arm cylinder 22S, and the load of the bucket cylinder 23S can be adopted. In the present embodiment, for example, the load of the arm cylinder 22S is detected as the cylinder load.

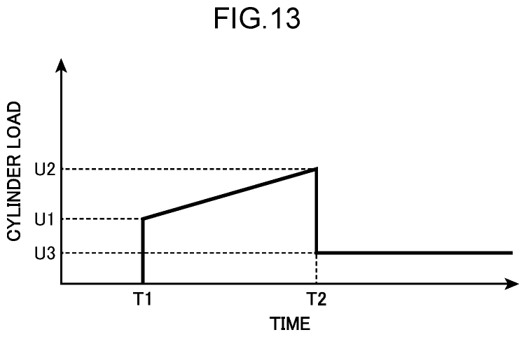

FIG. 13 is a graph illustrating an example of a temporal change of the cylinder load (the load of the arm cylinder 22S in the present embodiment) accompanying the execution of the predetermined excavation operation by the work attachment 20.

At the time T1, the distal end portion 23b of the bucket 23 comes into contact with the ground surface G in order for the work attachment 20 to take the excavation start posture, whereby the cylinder load of the arm cylinder 22S rises to U1 at once. Next, when the work attachment 20 starts the predetermined excavation operation from the excavation start posture, the excavation resistance acting on the bucket 23 gradually increases as the bucket 23 pivots about the proximal end portion 23a as a fulcrum, so that the cylinder load gradually increases from U1 to U2. Thereafter, the entire bucket 23 comes out above the ground surface G and the work attachment 20 is in the excavation completion posture, and at the same time, the cylinder load decreases to U3 at once, and thereafter, is maintained constant at the cylinder load balanced with the weight of the earth E held by the bucket 23.

The excavation time detection unit 507 acquires the time waveform of the cylinder load illustrated in FIG. 13 described above by monitoring the cylinder load of the arm 22 by a sensor (not illustrated) (for example, a load cell or a pressure sensor). Then, the excavation time detection unit 507 detects (calculates) the time (=T2−T1) from the time T1 to the time T2 as the excavation time which is the time required for the predetermined excavation operation of the work attachment 20 based on the acquired time waveform of the cylinder load.

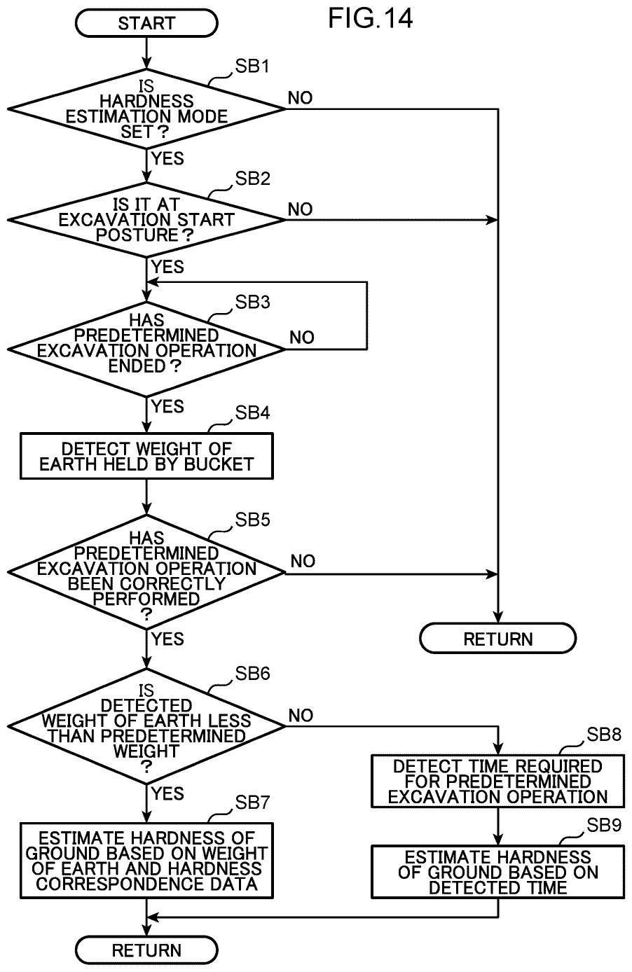

FIG. 14 is a flowchart illustrating an example of hardness estimation processing executed by the controller 50 according to the second embodiment.

The processing from step SB1 to step SB5 is similar to the processing from step SA1 to step SA5 in the first embodiment, and the processing from step SB6 is different from that in the first embodiment. Hereinafter, only the processes after step SB6 will be described, and the description of steps SB1 to SB5 before step SB6 will be omitted.

That is, in step SB6, the hardness estimation unit 503 determines whether the weight of the earth E of the bucket 23 detected by the weight detection unit 502 in the processing of step SB4 is less than a predetermined weight. Here, the predetermined weight is, for example, a weight corresponding to the maximum loading amount of the earth E with respect to the bucket 23 (a stacked state in which earth is spilled outside the bucket 23 when being loaded any more), and corresponds to, for example, the maximum earth weight w2 defined in the hardness correspondence data D in the present embodiment.

When the hardness estimation unit 503 determines that the weight of the earth E of the bucket 23 detected by the weight detection unit 502 is less than the predetermined weight (YES in step SB6), the process proceeds to step SB7, and similarly to the first embodiment, the hardness estimation unit 503 estimates the hardness of the ground based on the weight of the earth E detected by the weight detection unit 502 and the hardness correspondence data D (step SB7), and then returns to the next step.

On the other hand, when the hardness estimation unit 503 determines that the weight of the earth E of the bucket 23 detected by the weight detection unit 502 is equal to or more than the predetermined weight (NO in step SB6), the process proceeds to step SB8, the excavation time detection unit 507 detects the excavation time required for executing the predetermined excavation operation by the work attachment 20, and after the detection, the process proceeds to step SB9, and the hardness estimation unit 503 estimates the hardness of the ground based on the excavation time detected by the excavation time detection unit 507.

Describing an example of the ground hardness estimation processing in step SB9, for example, assuming that the excavation time when the predetermined excavation operation is executed on the ground (in this example, the ground having the hardness h1 corresponding to the maximum earth weight w2 defined by the hardness correspondence data D of FIG. 6) in which the weight of the earth E excavated and held by the bucket 23 by the predetermined excavation operation is a weight corresponding to the maximum loading amount is Tmax, and the execution time of the predetermined excavation operation detected by the excavation time detection unit 507 is Treal, the ground hardness H can be estimated by the following Expression 7.

$$H = h 1 * ( Tmax / Treal ) \qquad ( Expression 7 )$$

Note that Tmax may be measured at the time of an excavation test at the time of creating the hardness correspondence data D and stored in the storage unit 504.

### (Operation and Effect of Second Embodiment)

In the present embodiment, the hydraulic excavator 1 further includes an excavation time detection unit 507 that detects an excavation time that is a time required for a predetermined excavation operation of the work attachment 20, and the hardness estimation unit 503 is configured to determine whether the weight of the earth E detected by the weight detection unit 502 is equal to or more than the predetermined weight after the predetermined excavation operation is executed by the work attachment 20 when estimating the hardness of the ground, and to estimate the hardness of the ground based on the excavation time detected by the excavation time detection unit 507 when determining that the weight is equal to or more than the predetermined weight.

According to this configuration, even when the hardness of the ground is excessively soft, the estimation accuracy of the ground hardness can be sufficiently secured. That is, when the ground hardness is excessively soft, the amount of earth excavated by the bucket 23 exceeds the maximum loading amount that can be held by the bucket 23 in the excavation completion posture, and thus, even if the ground hardness changes, the weight of the earth E held by the bucket 23 does not change at a constant level because the surplus spills down, and the estimation accuracy of the ground hardness cannot be sufficiently secured. On the other hand, in the above configuration, when the weight of the earth E held by the bucket 23 exceeds the predetermined weight (that is, a case where the hardness of the ground is considered to be so soft that the earth weight held by the bucket 23 does not change even when the hardness of the ground changes), the estimation processing of the ground hardness is executed based on the excavation time required for the predetermined excavation operation. The upper limit value of the excavation time required for the predetermined excavation operation is not limited unlike the earth weight held by the bucket 23, and the excavation time becomes longer as the hardness of the ground is softer. Therefore, when the hardness of the ground is excessively soft, the estimation accuracy can be improved by executing the estimation processing of the ground hardness by the hardness estimation unit 503 based on the excavation time.

### Third Embodiment

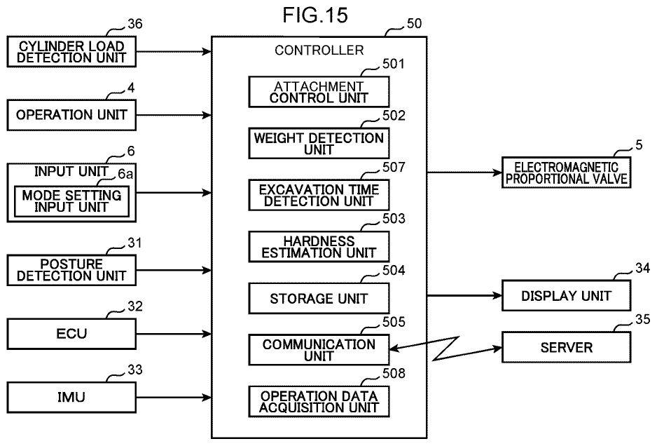

FIG. 15 is a diagram corresponding to FIG. 3 illustrating a third embodiment. The present embodiment is different from the first embodiment in that the hardness estimation unit 503 estimates the hardness of the ground based on the weight of the earth held by the bucket 23 by the predetermined excavation operation and the operation data J of the work attachment 20 during the excavation operation acquired by an operation data acquisition unit 508.

Specifically, the controller 50 further includes the operation data acquisition unit 508. In addition, the controller 50 is connected to a cylinder load detection unit 36 so as to be able to transmit and receive signals.

As an example, the cylinder load detection unit 36 includes a differential pressure sensor attached to the boom cylinder 21S. The differential pressure sensor detects a differential pressure between the pressure in the rod chamber and the pressure in the cylinder chamber in the boom cylinder 21S as a cylinder load. The cylinder load detection unit 36 transmits information on the detected cylinder load to the controller 50. The cylinder load is not limited to the differential pressure between the rod chamber and the cylinder chamber, and may be the pressure of the rod chamber or the pressure of the cylinder chamber. The target cylinder is not limited to the boom cylinder 21S, and may be an arm cylinder 22S, a bucket cylinder 23S, or the like.

The operation data acquisition unit 508 acquires the operation data J including an operation parameter related to the operating state of the work attachment 20 and correlated with the hardness of the ground to be subjected to the excavation operation and a numerical value related to the operation parameter, and stores the acquired operation data J in the storage unit 504.

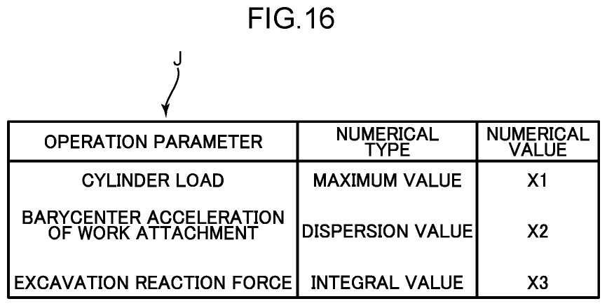

FIG. 16 is a diagram illustrating an example of the operation data J acquired by the operation data acquisition unit 508. In the example of this drawing, as an example of the operation parameter, a cylinder load, a barycenter acceleration of the work attachment 20, and an excavation reaction force acting on the work attachment 20 are illustrated. In addition, the maximum value of the cylinder load, the dispersion value of the barycenter acceleration of the work attachment 20, and the integral value of the excavation reaction force are exemplified as numerical values regarding the respective operation parameters. Note that the operation parameters mentioned here are merely examples, and may include, for example, the acceleration increasing rate of the barycenter of the work attachment 20 (the temporal change rate of the barycenter acceleration), the barycenter acceleration of the arm 22, the barycenter speed of the arm 22, the acceleration increasing rate of the arm 22, and the like.

The operation data acquisition unit 508 acquires a differential pressure between the rod chamber and the cylinder chamber of the boom cylinder 21S as an example of the cylinder load. This cylinder load is detected by the cylinder load detection unit 36. During the excavation operation of the work attachment 20, the operation data acquisition unit 508 holds the maximum value up to the present time of the differential pressure of the boom cylinder 21S received by the cylinder load detection unit 36, and updates the maximum value every time the differential pressure exceeds the maximum value at the present time. Then, the operation data acquisition unit 508 acquires the maximum value of the cylinder load during the excavation operation of the work attachment 20.

Further, the operation data acquisition unit 508 acquires (calculates) the barycenter acceleration of the work attachment 20 based on the information from the posture detection unit 31. Specifically, when the operator operates the operation unit 4 to cause the work attachment 20 to execute the predetermined excavation operation, the operation data acquisition unit 508 calculates the combined barycenter speed Vg of the work attachment 20 based on the information from the posture detection unit 31, and calculates the temporal change rate of the combined barycenter speed Vg as the barycenter acceleration. Then, during the excavation operation of the work attachment 20, the operation data acquisition unit 508 acquires the time history of the barycenter acceleration up to the current point of time, and calculates the dispersion value of the barycenter acceleration based on the acquired time history. Then, the operation data acquisition unit 508 acquires the dispersion value of the barycenter acceleration of the work attachment 20 during the excavation operation of the work attachment 20.

Further, the operation data acquisition unit 508 acquires (calculates) an integral value of the excavation reaction force acting on the bucket 23 during the execution of the predetermined excavation operation by the work attachment 20. Here, the excavation reaction force is a reaction force that the bucket 23 receives from the ground surface during excavation. Specifically, the operation data acquisition unit 508 calculates the excavation reaction force at each time based on the loads of the three cylinders 21S to 23 detected by the cylinder load detection unit 36 and the information on the posture of the work attachment 20 detected by the posture detection unit 31, and calculates a value obtained by integrating the calculated excavation reaction force with the time from the start to the end of the predetermined excavation operation. In order to acquire the excavation reaction force, for example, a load detection sensor such as a load cell attached to the bucket 23 may be used.

The hardness estimation unit 503 executes first calculation processing of calculating earth weight correspondence hardness H0 (corresponding to first hardness) corresponding to the weight of the earth held in the bucket 23 after the excavation operation, and second calculation processing of calculating three operating situation correspondence hardness H1, H2, and H3 (corresponding to second hardness) corresponding to numerical values of the three operation parameters in the operation data J acquired by the operation data acquisition unit 508 during the excavation operation. Then, the hardness estimation unit 503 estimates the hardness of the ground based on the earth weight correspondence hardness H0 and the three operating situation correspondence hardness H1, H2, and H3.

The hardness estimation unit 503 stores the estimated hardness of the ground, outputs an average value of the estimated hardness for a predetermined number of times as the hardness of the ground, and causes the display unit 34 to display the average value.

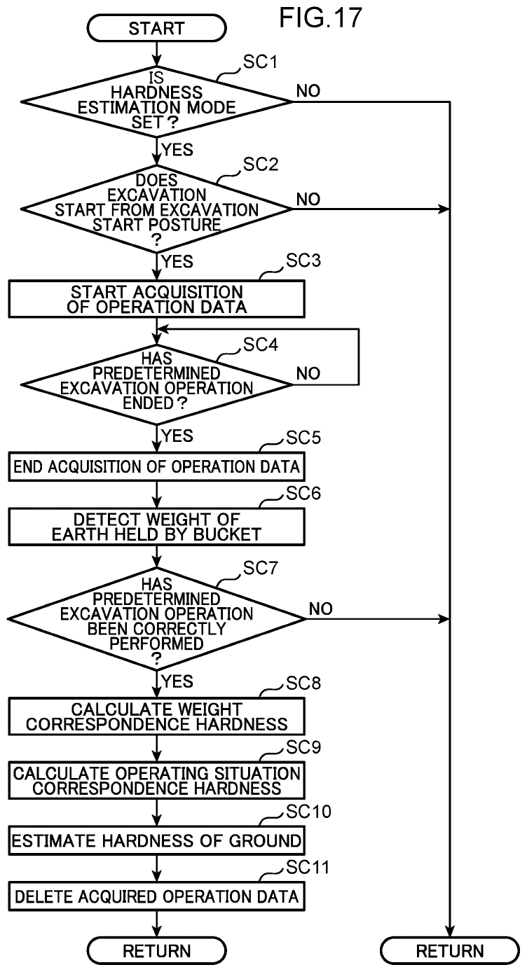

Next, FIG. 17 is a flowchart illustrating an example of the ground hardness estimation processing executed by the hardness estimation unit 503 of the present embodiment, and is a diagram corresponding to FIG. 9 of the first embodiment. Note that, in the following description, description of processing contents similar to those in FIG. 9 of the first embodiment will be omitted as appropriate.

In step SC1, processing similar to that in step SA1 of the first embodiment is executed.

In step SC2, it is determined whether the excavation is actually started from the state in which the work attachment 20 takes the excavation start posture (FIG. 4A). Here, whether the work attachment 20 is in the excavation start posture may be estimated based on the posture information of the work attachment 20 detected by the posture detection unit 31 as in step SA2, and whether the work attachment 20 actually starts excavation from the excavation start posture may be estimated based on an operation signal of an operation lever or the like input from the operation unit 4. In a case where the determination in step SC2 is NO (that is, a case where the excavation is not started although the work attachment 20 takes the excavation start posture which is the initial posture, or a case where the excavation by the work attachment 20 is started but the initial posture is not the excavation start posture), the process returns, whereas if the determination is YES, the process proceeds to step SC3.

In step SC3, acquisition of the operation data J is started. Specifically, acquisition of the maximum value of the cylinder load, the dispersion value of the barycenter acceleration of the work attachment 20, and the integral value of the excavation reaction force acting on the work attachment 20 is started.

In step SC4, it is determined whether the predetermined excavation operation by the work attachment 20 is ended, and when this determination is NO, the processing of step SC4 is continued. On the other hand, when the determination is YES, the process proceeds to step SC5.

In step SC5, the acquisition of the operation data J is terminated.

In steps SC6 and SC7, processes similar to steps SA4 and SA5 of the first embodiment are executed.

In step SC8, the earth weight correspondence hardness corresponding to the weight of the earth held in the bucket 23 is calculated by executing the first calculation processing. The calculation of the earth weight correspondence hardness is performed based on the weight of the earth E on the bucket 23 detected by the weight detection unit 502 and the hardness correspondence data D (hereinafter, referred to as first hardness correspondence data D) illustrated in FIG. 6, as in the first embodiment.

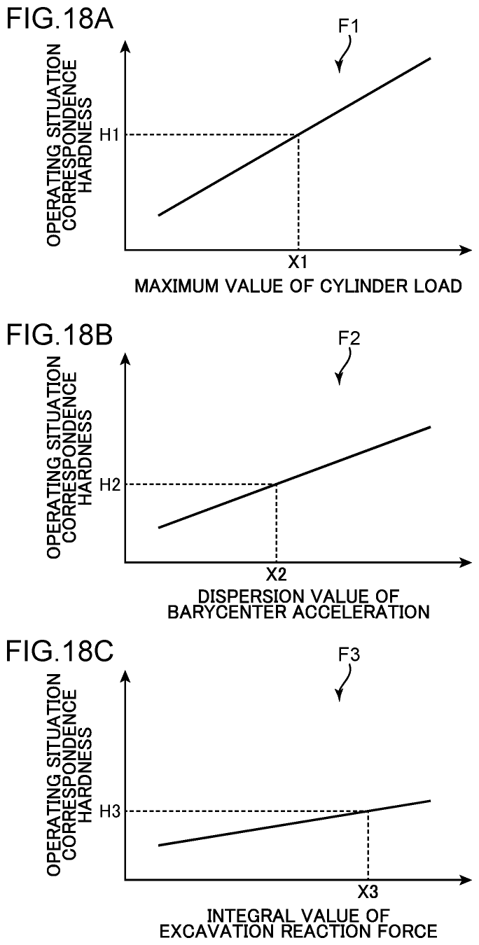

In step SC9, the operating situation correspondence hardness is calculated by executing the second calculation processing. The operating situation correspondence hardness is calculated based on the maximum value of the cylinder load included in the operation data J acquired by the operation data acquisition unit 508, the dispersion value of the barycenter acceleration of the work attachment 20, and the integral value of the excavation reaction force of the work attachment 20, and the second hardness correspondence data F1, F2, and F3 (see FIGS. 18A to 18C) stored in advance in the storage unit 504. The second hardness correspondence data F1, F2, and F3 are data in which numerical values relating to the three operation parameters are associated with ground hardness, and are acquired in advance by experiments or the like and stored in the storage unit 504. It can also be said that the second hardness correspondence data F1, F2, and F3 are data defining a change in the operation data J due to a difference in hardness of the ground. As illustrated in FIG. 16, in this example, since the maximum value of the cylinder load indicated by the operation data J is X1, the barycenter acceleration of the work attachment 20 is X2, and the integral value of the excavation reaction force is X3, the operating situation correspondence hardness corresponding to the maximum value X1 of the cylinder load is calculated as H1, the operating situation correspondence hardness corresponding to the barycenter acceleration X2 of the work attachment 20 is calculated as H2, and the operating situation correspondence hardness corresponding to the excavation reaction force X3 is calculated as H3 based on the second hardness correspondence data F1 to F3 illustrated in FIGS. 18A to 18C. FIG. 20 illustrates data indicating the acquisition result of the operating situation correspondence hardness, and the data is stored in the storage unit 504.

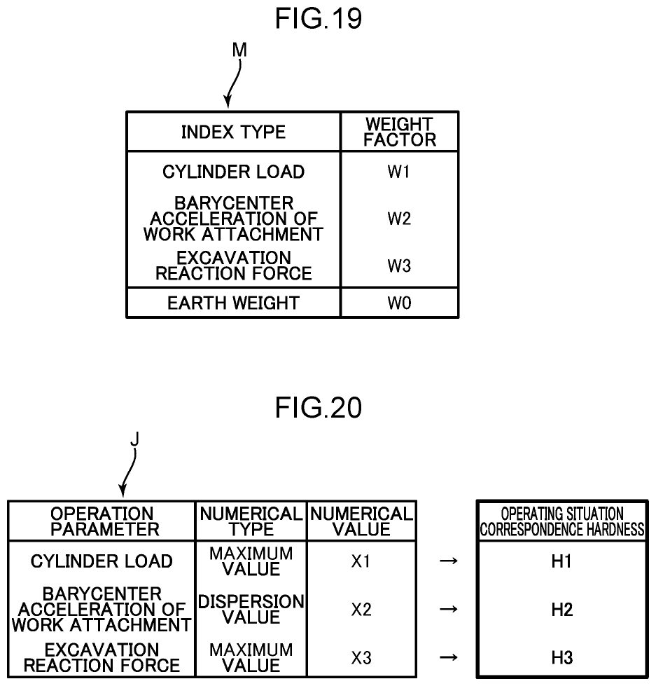

In step SC10, the hardness of the ground is estimated based on the weight correspondence hardness H0 calculated in step SC8, the three operating situation correspondence hardness H1, H2, and H3 corresponding to the respective operation parameters calculated in step SC9, and the weight factors W0, W1, W2, and W3 given in advance to the earth weight and the respective operation parameters. Specifically, when the estimated hardness of the ground is Ih, Ih is calculated as Ih=H0*W0+H1*W1+H2*W2+H3*W3. FIG. 19 illustrates weight factor data M defining the weight factors W0, W1, W2, and W3, which is stored in the storage unit 504 in advance. The weight factors W0, W1, W2, and W3 are set higher as the operation parameters have a greater influence in the estimation of the ground hardness. The relationship of W0+W1+W2+W3=1 is satisfied. Then, after the processing of step SC10 is completed, the process proceeds to step SC11.

In step SC11, the operation data J acquired in step SC3 is deleted, and the information on the ground hardness h1 estimated in step SC10 is output to the display unit 34, and then the process returns to step SC1. Then, the processing from step SC1 to step SC11 is repeated.

The hardness estimation unit 503 outputs the estimated ground hardness Ih to the display unit 34 every time the predetermined excavation operation is executed. The hardness estimation unit 503 stores the estimated ground hardness Ih every time the predetermined excavation operation is performed, calculates an average value lave of the stored ground hardness Ih for a predetermined number of times when the stored ground hardness Ih reaches a predetermined number of times (the predetermined number of times is 2 or more), and outputs the calculated average value lave to the display unit 34.

The display unit 34 displays the latest ground hardness Ih received from the hardness estimation unit 503 on the information display screen Q every time the ground hardness Ih is estimated by the hardness estimation unit 503 (that is, every time the predetermined excavation operation is performed). In addition, the display unit 34 displays the latest average value lave received from the hardness estimation unit 503 on the information display screen Q every time the average value lave (=ΣIh/n) is calculated by the hardness estimation unit 503 (that is, every time the predetermined excavation operation is executed the predetermined number of times).

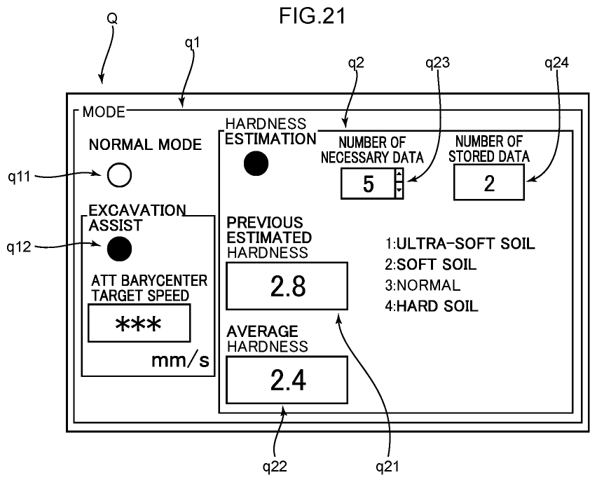

FIG. 21 is a diagram illustrating an example of the information display screen Q displayed on the display unit 34.

The information display screen Q includes an operation mode display area q1 and a hardness information display area q2.

The operation mode display area q1 includes a mode display unit q11 that displays whether the normal operation mode is set at the present time, and an assist information display unit q12 that displays information regarding the above-described excavation assist control. The mode display unit q11 displays the display mark with a white circle when the normal operation mode is set, and displays the display mark with a black circle when the hardness estimation mode is set. The assist information display unit q12 displays the display mark with a black circle when the assist control is enabled, and displays the display mark with a white circle when the assist control is disabled.

The hardness information display area q2 includes a display unit q21 that displays the latest ground hardness Ih estimated by the hardness estimation unit 503 and a display unit q22 that displays the average value lave of the ground hardness. An upper right portion of the hardness information display area q2 is provided with an input box q23 for inputting the number of data (the predetermined number of times) used when the ground hardness averaging processing calculated by the hardness estimation unit 503 is executed, and a display unit q24 for displaying acquisition and collection of the ground hardness at the present time (the number of times estimated by the hardness estimation unit 503) is provided on the right side thereof.

### Operation and Effect

As described above, in the present embodiment, when executing the estimation processing of the ground hardness, the hardness estimation unit 503 executes the first calculation processing of calculating the hardness of the ground corresponding to the earth weight as the earth weight correspondence hardness H0 based on the earth weight detected by the weight detection unit 502 after the execution of the predetermined excavation operation by the work attachment 20 and the first hardness correspondence data D, and the second calculation processing of calculating the hardness of the ground corresponding to the acquired operation data J as the operating situation correspondence hardness H1, H2, and H3 based on the operation data J acquired by the operation data acquisition unit 508 during the predetermined excavation operation and the second hardness correspondence data F1, F2, and F3 defining the change in the operation data J due to the difference in ground hardness. The hardness estimation unit 503 is configured to estimate the hardness of the ground based on the earth weight correspondence hardness H0 calculated in the first calculation processing and the second hardness H1, H2, and H3 calculated in the second calculation processing.

According to this configuration, since the hardness of the ground is estimated based on not only the weight of the earth E held by the bucket 23 by the predetermined excavation operation but also the operation data J of the work attachment 20 during the excavation operation, the estimation accuracy of the ground hardness can be improved. That is, the weight of the earth held by the bucket 23 by the predetermined excavation operation easily changes due to a change in the track of the bucket 23 caused by the bucket 23 coming into contact with the foreign matter during the excavation operation, roughness of the topography, and the like. For this reason, in a case where the ground hardness is estimated based only on the weight of the earth held in the bucket 23, there is a possibility that the estimation accuracy of the hardness of the ground is deteriorated due to the variation in the weight of the earth held in the bucket 23. On the other hand, in the above configuration, the estimation processing of the ground hardness is executed based on the earth weight correspondence hardness H0 based on the earth weight held by the bucket 23 after the predetermined excavation operation and the operating situation correspondence hardness based on the operation parameter of the work attachment 20 during the predetermined excavation operation, so that the estimation accuracy can be improved as much as possible as compared with the case of estimating the ground hardness based only on the earth weight.

The operation data J is data including a numerical value related to an operation parameter related to the operating state of the work attachment 20 during the excavation operation and correlated with the hardness of the ground to be subjected to the excavation operation. In the present embodiment, as an example, the operation parameters include three of a cylinder load of the work attachment 20, a barycenter acceleration of the work attachment 20, and an excavation reaction force acting on the work attachment 20, and a maximum value, a dispersion value, and an integral value are acquired as numerical values related to the respective operation parameters.

In this way, by setting a parameter having a strong correlation with the hardness of the ground as the operation parameter, it is possible to improve the estimation accuracy of the hardness of the ground by the hardness estimation unit 503. That is, the cylinder load of the work attachment 20 increases as the hardness of the ground becomes harder. In addition, since the vibration of the work attachment 20 during the excavation operation increases as the hardness of the ground becomes harder, the barycenter acceleration of the work attachment 20 also vibratively changes. In addition, as the hardness of the ground becomes harder, the excavation reaction force acting on the work attachment 20 also increases. As described above, since the three parameters have a strong correlation with the hardness of the ground, by setting these parameters as operation parameters, the degree of coincidence between the operating situation correspondence hardness based on the operation parameters and the actual hardness of the ground increases, and accordingly, the estimation accuracy of the ground hardness based on the operating situation correspondence hardness and the weight correspondence hardness can be improved.

In addition, in the present embodiment, the hardness estimation unit 503 is configured to acquire three operating state correspondence hardness H1, H2, and H3 corresponding to three operation parameters of a cylinder load, a barycenter acceleration of the work attachment 20, and the excavation reaction force, and the earth weight correspondence hardness H0, and estimate the hardness of the ground based on weight factors W0, W1, W2, and W3 set in advance for each of the hardness H0, H1, H2, and H3, at the time of executing the estimation processing.

According to this configuration, the weight factor is set high for an index having a strong correlation with the hardness of the ground, and the weight factor is set low for an index having a low correlation, whereby the estimation accuracy of the ground hardness can be improved. Note that the weight factors W0, W1, W2, and W3 may have the same value, and in this case, the estimated hardness can be calculated as Ih=(H1+H2+H3+H4)/4.

Furthermore, in the present embodiment, the hardness estimation unit 503 stores the hardness of the ground every time the predetermined excavation operation is executed, and when the stored hardness of the ground reaches a predetermined number of times (the predetermined number of times is 2 or more), calculates an average value lave of the stored ground hardness for the predetermined number of times, and outputs information of the calculated average value to the display unit 34.

According to this configuration, the hardness estimation unit 503 outputs the average value of the ground hardness for a predetermined number of times as the estimation result of the ground hardness. This makes it possible to average variations in ground hardness estimated by the hardness estimation unit 503. Therefore, the worker can perform appropriate excavation work according to the ground hardness, for example, by performing excavation work based on the averaged ground hardness.

### (First Modification of Third Embodiment)

In the third embodiment, as an example of the operation parameter, the cylinder load, the barycenter acceleration of the work attachment 20, and the excavation reaction force acting on the work attachment 20 are exemplified, and the maximum value, the dispersion value, and the integral value are exemplified as numerical values related thereto, but the present invention is not limited thereto.

That is, the operation parameter may be, for example, any one of a cylinder load, a barycenter acceleration of the work attachment 20, and the work attachment 20. In addition, the operation parameter may include a barycenter speed of the work attachment 20. That is, the operation parameter may be any parameter as long as it is related to the operating state of the work attachment 20 during the excavation operation and has correlation with the hardness of the ground to be subjected to the excavation operation, and the number thereof is not limited to a plurality and may be one.

In the above embodiment, the maximum value, the dispersion value, and the integral value have been described as the numerical values related to the three operation parameters (indexes). However, the present invention is not limited to this, and the numerical values of the operation parameters themselves may be used. The related numerical value is not limited to a constant, and may be a time history (that is, waveform data indicating a temporal change).

### (Second Modification of Third Embodiment)

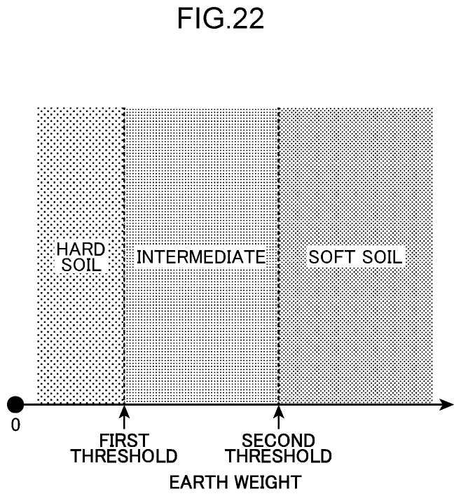

In the third embodiment, the hardness corresponding to each index is calculated using the first hardness correspondence data D and the second hardness correspondence data F1, F2, and F3 in a graph format, and the hardness Ih of the ground is estimated by multiplying each hardness by a weight factor. However, the present invention is not limited to this. As the first hardness correspondence data D and the second hardness correspondence data F1, F2, and F3, level-classified hardness correspondence data may be used as illustrated in FIG. 22 to be described later. In this case, for example, it is possible to determine which level of hardness the hardness corresponding to each index belongs to, specify the largest hardness level, and estimate the specified hardness as the hardness of the ground.

### (Third Modification of Third Embodiment)

In the third embodiment, the hardness estimation unit 503 sets the weight factor as a predetermined constant, but is not limited thereto, and may be configured to change the weight factor based on the posture of the work attachment 20 during the predetermined excavation operation or the time-series change of the numerical value in the operation data J. According to this configuration, it is possible to improve the estimation accuracy of the hardness of the ground by the hardness estimation unit 503 as much as possible by lowering the weight of the index predicted to decrease the estimation accuracy.

For example, when the frontward descending slope or groove is excavated, the position of the bucket 23 in the excavation start posture is located below the ground surface on which the hydraulic excavator 1 is located. However, as the bucket 23 is located below the ground surface, earth easily flows into the bucket 23 during the excavation operation as compared with the case of excavating the flat ground, so that the difference in the weight of the earth due to the difference in the hardness of the ground is less likely to appear. Therefore, the hardness estimation unit 503 may be configured to set the weight factor W0 corresponding to the sand weight correspondence hardness H0 to be relatively small and set the other weight factors W1, W2, and W3 to be relatively large, for example, when it is determined that the frontward descending slope or groove is in the state of being excavated based on the posture of the work attachment 20 detected by the posture detection unit 31. As a result, the estimation accuracy of ground hardness by the hardness estimation unit 503 can be improved as much as possible.

Furthermore, as another example, in a case where the distal end of the bucket 23 is caught by a rigid body such as a locally existing stone even if the ground is soft as a whole, there is a possibility that the barycenter acceleration of the work attachment 20 becomes locally high. Therefore, the hardness estimation unit 503 may acquire waveform data indicating a temporal change in the barycenter acceleration of the work attachment 20, determine whether there is a feature indicating such contact between the bucket 23 and the rigid body (for example, a waveform feature in which the barycenter acceleration rapidly increases vertically) in the waveform data, and when it is determined that there is the feature, a weight factor for the index (barycenter acceleration) may be set relatively small, and the other weight factors may be set relatively large. As a result, the estimation accuracy of ground hardness by the hardness estimation unit 503 can be improved as much as possible.

### OTHER EMBODIMENTS

Although an example of the construction machine according to the embodiment of the present invention has been described above, the present invention is not limited thereto, and for example, the following modifications can be adopted.

(1) In each of the above embodiments and modifications, the command signal for driving the arm 22 and the bucket 23 is a command signal corresponding to the operation amount of the operation unit 4, and the command signal for driving the boom 21 is configured by the command signal corresponding to the operation amount of the operation unit 4 and the adjustment command signal input from the controller 50 to the electromagnetic proportional valve 5, but the present invention is not limited thereto. That is, the hydraulic excavator 1 may include a controller (control unit) capable of executing control of generating a command signal for causing the work attachment 20 to execute the predetermined excavation operation and inputting the generated command signal to the drive unit. According to this configuration, for example, by providing an automatic driving switch and executing the control when the switch is turned on, it is possible to cause the work attachment 20 to automatically execute the predetermined excavation operation satisfying the target speed condition. As a result, it is possible to suppress variations in the movement of the work attachment 20 due to manual operation by the operator, and thus, it is possible to improve the estimation accuracy of the ground hardness by the hardness estimation unit 503.

(2) In each of the above embodiments and modifications, the hardness correspondence data D is graph data in which the earth weight and the ground hardness of the bucket 23 acquired by the excavation test are associated with each other by the approximate straight line I.

However, the present invention is not limited to this, and for example, the hardness correspondence data D may be data in which the hardness of the ground is divided into a plurality of levels according to the earth weight. FIG. 22 is a diagram (diagram corresponding to FIG. 6 of the first embodiment) illustrating an example of the hardness correspondence data by the leveling. In the example of this drawing, the hardness of the ground is divided into three levels of a hard soil level, an intermediate level, and a soft soil level, and the earth weight corresponding to each hardness level is indicated on the horizontal axis. In the example of this drawing, a first threshold for partitioning the hard soil level and the intermediate level and a second threshold for partitioning the soft soil level and the intermediate level are set. If the weight of the earth held in the bucket 23 after the predetermined excavation operation is less than the first threshold, the ground hardness can be estimated as the hard soil level. If the earth weight is within a range from the first threshold to the second threshold, the ground hardness can be estimated as the intermediate level. If the earth weight exceeds the second threshold, the ground hardness can be estimated as the soft soil level.

(3) In each of the above embodiments and modifications, as the target speed condition at the time of execution of the predetermined excavation operation by the work attachment 20, a condition that the combined barycenter speed Vg of the work attachment 20 is constant (=target barycenter speed r) is set, but the present invention is not limited thereto. That is, first, the target speed defined by the target speed condition is not necessarily the combined barycenter speed Vg of the work attachment 20 as in each of the above embodiments, and may be the speed of the barycenter of the arm 22. In addition, the target speed (the target barycenter speed r in the example of the embodiment) defined by the target speed condition does not necessarily have to be a constant value as in each of the embodiments, and for example, a speed profile that linearly increases with time may be set as a target, or a speed profile that linearly increases and then becomes a constant value may be set as a target. Note that how to set the target speed condition is not limited, but the target speed condition of the predetermined excavation operation of the work attachment 20 when creating the hardness correspondence data D and the target speed condition of the predetermined excavation operation of the work attachment 20 when actually estimating the ground hardness need to be the same.

(4) In each of the above embodiments and modifications, each of the boom 21, the arm 22, and the bucket 23 operates at the rotational angular speed corresponding to the operation amount of the operation unit 4. However, the present invention is not limited to this. For example, the controller 50 may perform control (hereinafter, referred to as excavation assist control) to determine the rotational angular speed of the bucket 23 based on the relative angular speed between the boom 21 and the arm 22 (the angular speed of the relative rotation of the arm 22 with respect to the boom 21). As a result, since the operation of the work attachment 20 is stabilized, the reproducibility of the excavation amount of earth by the bucket 23 can be improved, and the estimation accuracy of the ground hardness can be improved. Here, the excavation assist control may be executed only in the hardness estimation mode, and the function may be turned off in the normal operation mode. In addition, the controller 50 may execute processing of changing a control parameter (for example, the degree of change in rotational angular speed or the like) when executing the excavation assist control to a value corresponding to the estimated ground hardness based on the estimation result of the ground hardness in the hardness estimation unit 503.

(5) In each of the above embodiments and modifications, the excavation start posture of the predetermined excavation operation by the work attachment 20 is in a state where the distal end portion 23b of the bucket 23 is in contact with the ground surface G. However, the present invention is not limited thereto, and for example, the distal end portion 23b of the bucket 23 may be in a state of penetrating the ground. In order to cause the distal end portion 23b of the bucket 23 to penetrate the ground surface G, for example, the cylinder load may be monitored, the boom 21 may be lowered until the cylinder load (for example, the load of the boom cylinder 21S) reaches a predetermined load, the lowering of the boom 21 may be stopped at the same time when the cylinder load reaches the predetermined load, and the posture of the work attachment 20 at the time of the stop may be set as the excavation start posture. As a result, since the predetermined excavation operation can be started from the state where the distal end portion 23b of the bucket 23 firmly bites into the ground surface G, it is possible to prevent idling of the bucket 23 and reliably excavate the earth by the bucket 23. Therefore, the excavation amount of earth by the bucket 23 can be sufficiently secured, and thus, the estimation processing of the ground hardness by the hardness estimation unit 503 can be accurately performed.

(6) In each of the above embodiments and modifications, the weight detection unit 502 is configured to detect the weight of the earth E held by the bucket 23 based on the balance of the moments around the rotation fulcrum S of the proximal end portion of the boom 21. However, the present invention is not limited to this. For example, the weight detection unit may be configured by a weight sensor (load cell or the like) disposed on the bottom surface of the bucket 23.

(7) In each of the above embodiments and modifications, the hardness correspondence data D is created based on an excavation test that is actually performed by causing the work attachment 20 to execute the predetermined excavation operation, but the present invention is not limited thereto. For example, the hardness correspondence data D may be created based on a computer simulation that simulates the predetermined excavation operation of the work attachment 20. In this case, the hardness correspondence data D can be created at a lower cost and in a shorter time than in a case where the excavation test is actually performed.

(8) In each of the above embodiments and modifications, as an example of the excavation start posture when the work attachment 20 is caused to execute the predetermined excavation operation, the posture (see FIG. 4A) in which the work attachment 20 is in the maximum reach posture and the ground angle of the bucket 23 is 70° to 120° has been described. However, the maximum reach posture is not necessarily required, and the ground angle of the bucket 23 is not necessarily 70° to 120°. That is, the excavation start posture may be the same posture at the time of creating the hardness correspondence data D and at the time of estimating the actual ground hardness based on the hardness correspondence data D, and is not limited to the posture illustrated in FIG. 4A described above. Similarly, the excavation completion posture is not limited to the posture illustrated in FIG. 4C, and may be the same posture at the time of creating the hardness correspondence data D and at the time of estimating the actual ground hardness based on the hardness correspondence data D.

(9) In each of the above embodiments and modifications, in steps SA5, SB5, and SC7, the hardness estimation unit 503 executes the determination processing (operation determination processing) as to whether the predetermined excavation operation by the work attachment 20 is correctly performed based on whether the earth weight held by the bucket 23 is in the range of the minimum earth weight w1 to the maximum earth weight w2, but the present invention is not limited thereto. That is, the hardness estimation unit 503 may be configured to execute the operation determination processing based on the distance from the proximal end portion of the work attachment 20 to the distal end of the bucket 23 at the start of the excavation and the operation input information of the work attachment 20 after the start of the predetermined excavation operation. Specifically, the hardness estimation unit 503 may be configured to determine that the predetermined excavation operation is correctly executed when the distance between the boom feet, which is the distance from the distal end of the bucket 23 to the proximal end of the boom 21 at the start of the predetermined excavation operation (excavation start posture), is greater than or equal to a predetermined threshold, and the pulling operation input of the arm 22 during the predetermined excavation operation of the work attachment 20 is greater than or equal to a predetermined time. As a result, it is possible to prevent the work of leveling the periphery of the machine body 1S from being erroneously determined as the predetermined excavation operation. The turning operation input during the execution of the predetermined excavation operation by the work attachment 20 may be added to the determination condition. According to this, it is possible to prevent the hardness estimation unit 503 from erroneously determining the pressing excavation operation of swinging the work attachment 20 while pressing the bucket 23 against the groove side surface or the ground surface as the predetermined excavation operation, for example.

(10) In each of the above embodiments and modifications, the controller 50 (an example of the speed condition setting unit) may be configured to reset the target speed condition after the work attachment 20 executes the predetermined excavation operation a predetermined number of times while satisfying the target speed condition. The predetermined number of times may be the same as or different from the predetermined number of times that is the number of times of sampling when the hardness estimation unit 503 calculates the average value of the hardness of the ground. When setting the target speed condition, the controller 50 acquires the hardness of the ground estimated by the hardness estimation unit 503 when the predetermined excavation operation is executed a predetermined number of times, and sets the target speed condition such that the excavation amount of the earth E excavated by the bucket 23 becomes an amount corresponding to the maximum loading amount that can be held by the bucket 23 when the ground having the acquired hardness is excavated by the predetermined excavation operation of the work attachment 20. The setting of the target speed condition is set by the same method as that described in FIG. 8 of the first embodiment. The correspondence relationship between the acquired hardness and the target speed condition under which the earth of the bucket 23 becomes the amount corresponding to the maximum loading amount may be acquired in advance by experiment or the like and stored in the storage unit 504 as target speed setting data. The hardness estimation unit 503 can set the target speed condition based on the target speed setting data and the acquired hardness.

According to this configuration, even when the hardness of the ground changes from soft soil to hard soil or from hard soil to soft soil as the excavation of the ground by the predetermined excavation operation progresses, the target speed condition is changed according to the changed hardness of the ground. Therefore, the excavation amount of the earth E by the bucket 23 can be sufficiently secured. That is, for example, when the work attachment 20 is driven under the target speed condition corresponding to soft soil even though the ground to be excavated is hard soil, the excavation amount of the earth E cannot be sufficiently secured. As a result, not only the estimation accuracy of the hardness of the ground decreases, but also the efficiency of excavation of the ground by the work attachment 20, which is the original purpose, may decrease. On the other hand, according to the above configuration, since the target speed condition according to the hardness of the ground is set, the above-described problem of the decrease in excavation efficiency can be avoided.

(11) In each of the above embodiments and modifications, the plurality of members constituting the work attachment 20 is configured by three members of the boom 21, the arm 22, and the bucket 23, but the present invention is not limited thereto. For example, the plurality of members may be configured by two members including the bucket 23, or may be configured by four or more members.

(12) In each of the above embodiments and modifications, the hydraulic excavator 1 that can travel on the ground surface has been described as an example of the construction machine, but the construction machine is not limited thereto, and may be a construction machine fixed to the ground surface. In addition, the driving system of the construction machine is not limited to the hydraulic driving system, and may be, for example, an electric type.

(13) The present invention includes any combination of the above embodiments and modifications and other embodiments.

Provided according to the present invention is a construction machine including a machine body, a work attachment that is mounted to the machine body, includes a bucket capable of excavating and holding earth constituting ground, and is capable of executing an excavation operation of the ground through the bucket, a weight detection unit that is capable of detecting a weight of the earth held by the bucket, and a hardness estimation unit that estimates hardness of the ground. The hardness estimation unit is configured to execute estimation processing of estimating hardness of the ground based on a weight of the earth detected by the weight detection unit and first hardness correspondence data defining a change in weight of the earth due to a difference in hardness of the ground after execution of a predetermined excavation operation in which the work attachment changes its posture while satisfying a target speed condition from an excavation start posture to an excavation completion posture capable of holding earth after excavation.

According to the present configuration, the hardness of the ground is estimated based on the weight of the earth held in the bucket by the predetermined excavation operation of the work attachment and the hardness correspondence data, so that the complicated arithmetic processing for determining the detection waveform by the sensor can be eliminated to easily estimate the ground hardness. Therefore, it is possible to reduce the risk of erroneous determination and improve the estimation accuracy of hardness of the ground as compared with the case where the features of the detection waveform of the sensor are determined by complicated arithmetic processing as in the related art. In addition, in the conventional processing, when the resolution (the number of levels of the ground hardness that can be estimated) in estimating the ground hardness is increased, it is necessary to finely classify the detection waveform by the sensor according to the ground hardness. Therefore, there is a problem that the number of types of detection waveforms to be determined in estimating the ground hardness increases, and the determination accuracy decreases (and the estimation accuracy of the ground hardness decreases). On the other hand, in the present configuration, since the estimation of the ground hardness is performed based on the weight of the earth held in the bucket, even if the resolution of the ground hardness is increased, the number of determination targets does not increase, and it is only necessary to determine the magnitude of the earth, so that the estimation accuracy of the ground hardness does not decrease.

Moreover, according to the present configuration, since the predetermined excavation operation can be incorporated into the normal excavation operation performed by the work attachment and the hardness of the ground can be estimated by the hardness estimation unit, a dedicated operation only for estimating the ground hardness is unnecessary, and the excavation operation by the work attachment can be efficiently performed.

The construction machine may include an operation data acquisition unit that acquires operation data related to an operating state of the work attachment during the excavation operation and having a correlation with hardness of ground that is subjected to the excavation operation. The hardness estimation unit may be configured to execute first calculation processing of calculating hardness of ground corresponding to a weight of the earth as first hardness based on the weight of the earth detected by the weight detection unit after execution of the predetermined excavation operation by the work attachment and the first hardness correspondence data when the estimation processing is executed, second calculation processing of calculating hardness of the ground corresponding to the acquired operation data as second hardness based on the operation data acquired by the operation data acquisition unit during the predetermined excavation operation and second hardness correspondence data defining a change in the operation data due to a difference in hardness of the ground, and estimating hardness of the ground based on the first hardness calculated in the first calculation processing and the second hardness calculated in the second calculation processing.

According to this configuration, since the hardness of the ground is estimated based on not only the weight of the earth held by the bucket by the predetermined excavation operation but also the operation data of the work attachment during the excavation operation, the estimation accuracy of the ground hardness can be improved. That is, the weight of the earth held by the bucket by the predetermined excavation operation easily changes due to a change in the track of the bucket caused by the bucket coming into contact with the foreign matter during the excavation operation, roughness of the topography, and the like. For this reason, in a case where the ground hardness is estimated based only on the weight of the earth held in the bucket, there is a possibility that the estimation accuracy of the hardness of the ground is deteriorated due to the variation in the weight of the earth held in the bucket. On the other hand, in the above configuration, the estimation processing of the ground hardness is executed based on the first hardness based on the earth weight held by the bucket after the predetermined excavation operation and the second hardness based on the operation parameter of the work attachment during the predetermined excavation operation, so that the estimation accuracy can be improved as much as possible as compared with the case of estimating the ground hardness based only on the earth weight.

The hardness estimation unit may be configured to execute operation determination processing of determining whether the predetermined excavation operation is correctly executed along a predetermined track when the predetermined excavation operation by the work attachment is executed, and not to execute the estimation processing when it is determined that the predetermined excavation operation is not correctly executed.

According to this configuration, when the predetermined excavation operation is not correctly executed, the estimation processing by the hardness estimation unit is not executed, so that erroneous estimation of the ground hardness by the hardness estimation unit can be prevented. Here, the case where the predetermined excavation operation is not correctly executed is, for example, a case where the speed state of the work attachment when the predetermined excavation operation is executed does not satisfy the target speed condition, and examples thereof include a case where the bucket idles in the air and a case where the pressing excavation operation is executed by slewing the machine body while pressing the bucket against the groove side surface and the ground surface. Note that not executing the estimation processing includes both a case where the estimation processing itself is not executed and a case where the estimation processing is executed but a result thereof is not output.

The operation data may be numerical data regarding an operation parameter related to an operating state of the work attachment during the excavation operation and having a correlation with hardness of ground to be subjected to the excavation operation, and the operation parameter may include at least one of a load of a cylinder that drives the work attachment, a barycenter speed of the work attachment, a barycenter acceleration of the work attachment, and an excavation reaction force acting on the work attachment.

In this way, by setting a parameter having a strong correlation with the hardness of the ground as the operation parameter, it is possible to improve the estimation accuracy of the hardness of the ground by the hardness estimation unit. That is, the drive cylinder load of the work attachment increases as the hardness of the ground becomes harder. In addition, since the vibration of the work attachment during the excavation operation increases as the hardness of the ground becomes harder, the barycenter speed and the barycenter acceleration of the work attachment also vibratively change. In addition, as the hardness of the ground becomes harder, the excavation reaction force acting on the work attachment also increases. As described above, since the four parameters have a strong correlation with the hardness of the ground, by setting these parameters as operation parameters, the degree of coincidence between the second hardness based on the operation parameters and the actual hardness of the ground increases, and accordingly, the estimation accuracy of the ground hardness based on the second hardness and the first hardness can be improved.

The operation data may be numerical data regarding at least one operation parameter related to an operating state of the work attachment during the excavation operation and having a correlation with hardness of ground to be subjected to the excavation operation, and the hardness estimation unit may be configured to calculate at least one second hardness corresponding to the at least one operation parameter and the first hardness corresponding to a weight of the earth when executing the estimation process, and estimate hardness of the ground based on the calculated at least one of the second hardness and the first hardness and a weight factor set in advance for each hardness.

According to this configuration, with respect to at least one second hardness based on the value of at least one operation parameter and the first hardness based on the weight of the earth held in the bucket, the weight factor is set high for an index having a strong correlation with the hardness of the ground, and the weight factor is set low for an index having a low correlation, whereby the estimation accuracy of the ground hardness can be improved.

The hardness estimation unit may be configured to store hardness of the ground estimated for each execution of the predetermined excavation operation, and estimate and output an average value of the stored hardness for a predetermined number of times as the hardness of the ground.

According to this configuration, since the estimated value of the ground hardness output from the hardness estimation unit is an average value for a predetermined number of times, even when variations in the estimated value of the ground hardness are large, it is possible to reduce an error in estimation of the ground hardness by taking the average value.

The hardness estimation unit may be configured to change the weight factor based on a posture of the work attachment at a time of the predetermined excavation operation or a time-series change of the numerical value in the operation data.

According to this configuration, by changing the weight factor based on the posture of the work attachment and the time-series change in the numerical value in the operation data, it is possible to improve the estimation accuracy of the ground by the hardness estimation unit as much as possible by setting the weight factor of the index (the earth weight and the operation parameter) having a large influence on the estimation accuracy of the hardness of the ground to be relatively large according to the situation during the excavation operation by the work attachment.

The hardness estimation unit may be configured to execute the operation determination processing based on the distance from the proximal end portion of the work attachment in the excavation start posture to the distal end of the bucket and the operation input information of the work attachment after the start of the predetermined excavation operation.

According to this configuration, since the operation determination processing is executed based on the distance from the proximal end portion of the work attachment to the distal end of the bucket in the excavation start posture, it is possible to prevent the state in which the work attachment levels the ground near the machine body from being erroneously determined as the predetermined excavation operation. In addition, by executing the operation determination processing based on the operation input information of the work attachment after the start of the predetermined excavation operation, it is possible to prevent the pressing excavation state or the like performed by slewing the machine body while pressing the bucket against the groove side surface or the ground surface from being erroneously determined to be the predetermined excavation operation.

The construction machine may further include a speed condition setting unit that sets the target speed condition. The speed condition setting unit may be configured to reset the target speed condition after the work attachment executes the predetermined excavation operation a predetermined number of times while satisfying the target speed condition, and the speed condition setting unit may acquire hardness of the ground estimated by the hardness estimation unit when the predetermined excavation operation is executed a predetermined number of times and resets the target speed condition such that an excavation amount of the earth excavated by the bucket becomes an amount corresponding to a maximum loading amount that can be held by the bucket when the ground having the acquired hardness is excavated by the predetermined excavation operation of the work attachment.

According to this configuration, even when the hardness of the ground changes from soft soil to hard soil or from hard soil to soft soil as the excavation of the ground by the predetermined excavation operation progresses, the target speed condition is changed according to the changed hardness of the ground. Therefore, the excavation amount of the earth by the bucket can be sufficiently secured. That is, when the work attachment is driven under the target speed condition corresponding to soft soil even though the ground to be excavated is hard soil, the excavation amount of earth by the bucket cannot be sufficiently secured, and not only the hardness estimation accuracy of the ground may decrease but also the excavation efficiency of the ground by the work attachment, which is the original purpose, may decrease. However, according to the above configuration, since the target speed condition corresponding to the hardness of the ground is set, the excavation efficiency by the work attachment does not decrease.

The work attachment may include a plurality of members movable relative to each other including the bucket, and the target speed condition may include a condition that a speed of a barycenter of one of the plurality of members connected to the bucket or a speed of a combined barycenter of the plurality of members is constant.

According to this configuration, the excavation by the bucket when causing the work attachment to execute the predetermined excavation operation can be stably executed, and the difference in the excavation locus due to the difference in the ground hardness can be clearly generated, and the estimation accuracy of the ground hardness can be improved. In particular, by making the speed of the combined barycenter of the plurality of members constant, the operation of the entire work attachment can be stabilized. That is, since the excavation operation by the work attachment is performed by cooperation of the plurality of members (for example, the boom, the arm, and the bucket), when the hardness estimation unit estimates the ground hardness, the work attachment is caused to execute the predetermined excavation operation so that the speed of the combined barycenter of the plurality of members becomes constant, whereby the excavation of the ground by the bucket can be stably (uniformly) executed. Therefore, since the reproducibility of the earth weight held by the bucket after the predetermined excavation operation (in other words, the reproducibility of the earth weight when the excavation operation is performed on the ground having the same hardness under the same speed condition) is secured, the estimation accuracy of the ground hardness based on the weight of the earth can be improved.

The construction machine may further include a speed state detection unit that detects a speed state of the work attachment during execution of the predetermined excavation operation, a deviation degree calculation unit that calculates information related to a deviation degree between the speed state detected by the speed state detection unit and the target speed condition, and a notification unit that notifies information related to the degree of deviation calculated by the deviation degree calculation unit.

According to this configuration, during execution of the predetermined excavation operation by the work attachment, the operator can recognize how much the speed state of the work attachment deviates from the target speed condition based on the information related to the deviation degree notified by the notification unit. Then, based on the recognition, the operator can correct the manual operation performed by the operator so that the speed state of the work attachment satisfies the target speed condition. Therefore, it is possible to prevent the speed of the combined barycenter of the work attachment from varying due to the manual operation of the operator. In addition, it is possible to improve the reproducibility of the weight of the earth held by the bucket after the predetermined excavation operation and to further improve the estimation accuracy of the ground hardness by the hardness estimation unit.

The construction machine may include a speed state detection unit that detects a speed state of the work attachment during execution of the predetermined excavation operation, a drive unit for driving the work attachment, and a control unit configured to execute control of determining a command signal to the drive unit so that the speed state satisfies the target speed condition based on a comparison between the speed state of the work attachment detected by the speed state detection unit and the target speed condition during execution of the predetermined excavation operation by the work attachment, and transmitting the determined command signal to the drive unit.

According to this configuration, during the execution of the predetermined excavation operation by the work attachment, the command signal is transmitted from the control unit to the drive unit so that the speed state of the work attachment satisfies the target speed condition (so-called feedback control is executed). Therefore, for example, when the work attachment is caused to execute the predetermined excavation operation by the manual operation of the operator, it is possible to prevent the speed of the combined barycenter of the work attachment from deviating from the target speed condition due to variations in the manual operation of the operator or the like. Note that the predetermined excavation operation of the work attachment may be executed not by manual operation but by automatic control by a controller, for example. In this case, a similar operation and effect can be obtained.

The target speed condition may be set such that an excavation amount of the earth excavated by the bucket becomes an amount corresponding to a maximum loading amount that can be held by the bucket when ground having a predetermined hardness on a soft side among hardness of ground defined in the hardness correspondence data is excavated by the predetermined excavation operation of the work attachment.

According to this configuration, the estimation accuracy of the ground hardness by the hardness estimation unit can be further improved. That is, since the excavation amount of earth by the bucket decreases as the hardness of the ground becomes harder, if the excavation amount at the time of excavating the soft ground is originally small, the excavation amount of earth by the bucket becomes zero only when the hardness of the ground becomes slightly harder, and thus, it is not possible to execute the estimation processing of the ground hardness based on the weight of the earth of the bucket described above. On the other hand, when the excavation amount of earth by the bucket at the time of excavating the soft ground exceeds the maximum loading amount of the bucket (the loading amount in a stacked state in which earth is spilled to the outside of the bucket when the bucket is loaded more than the maximum loading amount), a part of the excavated earth spills from the bucket, so that the amount of earth held by the bucket is maintained at the maximum loading amount even if the ground hardness slightly changes. For this reason, a change in the ground hardness is not reflected in the weight of the earth held in the bucket, and the ground hardness cannot be accurately estimated. Therefore, in the present configuration, the target speed condition when executing the predetermined excavation operation is set such that the excavation amount of earth by the bucket in the case of excavating the ground having the predetermined hardness on the soft side in the hardness correspondence data becomes an amount corresponding to the maximum loading amount that can be held by the bucket. As a result, the weight of the earth held by the bucket by the predetermined excavation operation of the work attachment can be greatly different between the case where the ground is soft soil and the case where the ground is hard soil, and accordingly, the estimation accuracy of the ground hardness by the hardness estimation unit can be improved.

The construction machine may further include an excavation time detection unit that detects an excavation time that is a time required for the predetermined excavation operation. The hardness estimation unit may be configured to determine whether a weight of the earth detected by the weight detection unit is a predetermined weight or more after the predetermined excavation operation is executed by the work attachment, and execute the estimation processing of estimating hardness of the ground based on a weight of the earth detected by the weight detection unit and the hardness correspondence data when it is determined that the weight is less than the predetermined weight, and execute estimation processing of estimating hardness of the ground based on an excavation time detected by the excavation time detection unit when it is determined that the weight is the predetermined weight or more.

According to this configuration, even when the ground hardness is excessively soft, the estimation accuracy of the ground hardness can be sufficiently secured. That is, when the ground hardness is excessively soft, the excavation amount of the earth by the bucket exceeds the maximum loading amount that can be held by the bucket in the excavation completion posture, and thus, even if the ground hardness changes, the weight of the earth held by the bucket does not change while being constant because the surplus spills over. For this reason, the estimation processing based on the weight of the earth held in the bucket described above cannot accurately estimate the ground hardness. Therefore, in the present configuration, when the weight of the earth held by the bucket exceeds a predetermined weight (for example, the weight corresponding to the maximum loading amount of the bucket) (that is, when it is considered that the hardness of the ground is so soft that the earth weight held by the bucket does not change even if the hardness of the ground changes), the processing of estimating the ground hardness is executed based on the time required for the predetermined excavation operation. The upper limit value of the excavation time required for the predetermined excavation operation is not limited unlike the earth weight held by the bucket, and the excavation time becomes longer as the ground hardness is softer. Therefore, in a case where the ground hardness is excessively soft, the estimation accuracy can be improved by executing the estimation processing of the ground hardness by the hardness estimation unit based on the excavation time as described above.

The construction machine may further include a drive unit that drives the work attachment, and a control unit that is capable of executing control of generating a command signal for causing the work attachment to execute the predetermined excavation operation and inputting a generated command signal to the drive unit.

According to this configuration, by causing the control unit to execute the control, a command signal for causing the work attachment to execute the predetermined excavation operation is input to the drive unit. Therefore, for example, it is possible to cause the work attachment to automatically perform the predetermined excavation operation. When such automatic control is performed, the work attachment can be operated without being affected by the operation of the worker, so that the target speed condition can be reliably satisfied when the predetermined excavation operation is performed, and the estimation accuracy of the ground hardness by the hardness estimation unit can be improved.

The construction machine may further include a communication unit that receives information on hardness of the ground estimated by the hardness estimation unit and transmits the received information on hardness to a management device provided at a place distant from the construction machine.

According to this configuration, the information on the hardness of the ground transmitted from the communication unit to the management device can be used for reviewing a construction plan, managing a construction history, and the like.

1. A construction machine comprising:
a machine body;
a work attachment that is mounted to the machine body, includes a bucket capable of excavating and holding earth constituting ground, and is capable of executing an excavation operation of the ground through the bucket;
a weight detection unit that is capable of detecting a weight of the earth held by the bucket; and
a hardness estimation unit that estimates hardness of the ground,
wherein the hardness estimation unit is configured to execute estimation processing of estimating hardness of the ground based on a weight of the earth detected by the weight detection unit and first hardness correspondence data defining a change in weight of the earth due to a difference in hardness of the ground after execution of a predetermined excavation operation in which the work attachment changes its posture while satisfying a target speed condition from an excavation start posture to an excavation completion posture capable of holding earth after excavation.

2. The construction machine according to claim 1, comprising an operation data acquisition unit that acquires operation data related to an operating state of the work attachment during the excavation operation and having a correlation with hardness of ground that is subjected to the excavation operation,
wherein the hardness estimation unit is configured to execute:
first calculation processing of calculating hardness of ground corresponding to a weight of the earth as first hardness based on the weight of the earth detected by the weight detection unit after execution of the predetermined excavation operation by the work attachment and the first hardness correspondence data when the estimation processing is executed;
second calculation processing of calculating hardness of the ground corresponding to the acquired operation data as second hardness based on the operation data acquired by the operation data acquisition unit during the predetermined excavation operation and second hardness correspondence data defining a change in the operation data due to a difference in hardness of the ground; and
estimating hardness of the ground based on the first hardness calculated in the first calculation processing and the second hardness calculated in the second calculation processing.

3. The construction machine according to claim 1, wherein the hardness estimation unit is configured to execute operation determination processing of determining whether the predetermined excavation operation is correctly executed along a predetermined track when the predetermined excavation operation by the work attachment is executed, and not to execute the estimation processing when it is determined that the predetermined excavation operation is not correctly executed.

4. The construction machine according to claim 2, wherein
the operation data is numerical data regarding an operation parameter related to an operating state of the work attachment during the excavation operation and having a correlation with hardness of ground to be subjected to the excavation operation, and
the operation parameter includes at least one of a load of a cylinder that drives the work attachment, a barycenter speed of the work attachment, a barycenter acceleration of the work attachment, and an excavation reaction force acting on the work attachment.

5. The construction machine according to claim 2, wherein
the operation data is numerical data regarding at least one operation parameter related to an operating state of the work attachment during the excavation operation and having a correlation with hardness of ground to be subjected to the excavation operation, and
the hardness estimation unit is configured to calculate at least one of the second hardness corresponding to the at least one operation parameter and the first hardness corresponding to a weight of the earth when executing the estimation processing, and estimate hardness of the ground based on the calculated at least one of the second hardness and the first hardness and a weight factor set in advance for each hardness.

6. The construction machine according to claim 1, wherein the hardness estimation unit is configured to store hardness of the ground estimated for each execution of the predetermined excavation operation, and output an average value of the stored hardness for a predetermined number of times as the hardness of the ground.

7. The construction machine according to claim 5, wherein the hardness estimation unit is configured to change the weight factor based on a posture of the work attachment at a time of the predetermined excavation operation or a time-series change of the numerical value in the operation data.

8. The construction machine according to claim 3, wherein the hardness estimation unit is configured to execute the operation determination processing based on a distance from a proximal end portion of the work attachment to a distal end of the bucket in the excavation start posture and operation input information of the work attachment after start of the predetermined excavation operation.

9. The construction machine according to claim 1, further comprising a speed condition setting unit that sets the target speed condition,
wherein the speed condition setting unit is configured to reset the target speed condition after the work attachment executes the predetermined excavation operation a predetermined number of times while satisfying the target speed condition, and
the speed condition setting unit acquires hardness of the ground estimated by the hardness estimation unit when the predetermined excavation operation is executed a predetermined number of times and resets the target speed condition such that an excavation amount of the earth excavated by the bucket becomes an amount corresponding to a maximum loading amount that can be held by the bucket when the ground having the acquired hardness is excavated by the predetermined excavation operation of the work attachment.

10. The construction machine according to claim 1, wherein
the work attachment includes a plurality of members movable relative to each other including the bucket, and
the target speed condition includes a condition that a speed of a barycenter of one of the plurality of members connected to the bucket or a speed of a combined barycenter of the plurality of members is constant.

11. The construction machine according to claim 1, further comprising:
a speed state detection unit that detects a speed state of the work attachment during execution of the predetermined excavation operation;
a deviation degree calculation unit that calculates information related to a deviation degree between the speed state detected by the speed state detection unit and the target speed condition; and
a notification unit that notifies information related to the degree of deviation calculated by the deviation degree calculation unit.

12. The construction machine according to claim 1, comprising:
a speed state detection unit that detects a speed state of the work attachment during execution of the predetermined excavation operation;
a drive unit for driving the work attachment; and
a control unit configured to execute control of determining a command signal to the drive unit so that the speed state satisfies the target speed condition based on a comparison between the speed state of the work attachment detected by the speed state detection unit and the target speed condition during execution of the predetermined excavation operation by the work attachment, and transmitting the determined command signal to the drive unit.

13. The construction machine according to claim 1, wherein the target speed condition is set such that an excavation amount of the earth excavated by the bucket becomes an amount corresponding to a maximum loading amount that can be held by the bucket when ground having a predetermined hardness on a soft side among hardness of ground defined in the hardness correspondence data is excavated by the predetermined excavation operation of the work attachment.

14. The construction machine according to claim 1, further comprising an excavation time detection unit that detects an excavation time that is a time required for the predetermined excavation operation,
wherein the hardness estimation unit is configured to determine whether a weight of the earth detected by the weight detection unit is a predetermined weight or more after the predetermined excavation operation is executed by the work attachment, and execute the estimation processing of estimating hardness of the ground based on a weight of the earth detected by the weight detection unit and the hardness correspondence data when it is determined that the weight is less than the predetermined weight, and execute estimation processing of estimating hardness of the ground based on an excavation time detected by the excavation time detection unit when it is determined that the weight is the predetermined weight or more.

15. The construction machine according to claim 1, further comprising:
a drive unit that drives the work attachment; and
a control unit that is capable of executing control of generating a command signal for causing the work attachment to execute the predetermined excavation operation satisfying the target speed condition and inputting a generated command signal to the drive unit.

16. The construction machine according to claim 1, further comprising a communication unit that receives information on hardness of the ground estimated by the hardness estimation unit and transmits the received information on hardness to a management device provided at a place distant from the construction machine.
